(19) United States
(12) Patent Application Publication
(10) Pub. No.: US 2022/0308704 A1
(43) Pub. Date: Sep. 29, 2022

(54) TRANSPARENT LAMINATE AND IMAGE DISPLAY APPARATUS

(71) Applicant: FUJIFILM Corporation, Tokyo (JP)

(72) Inventors: Kentaro Toyooka, Shizuoka (JP); Masaya Suzuki, Shizuoka (JP)

(73) Assignee: FUJIFILM Corporation, Tokyo (JP)

(21) Appl. No.: 17/714,348

(22) Filed: Apr. 6, 2022

Related U.S. Application Data
(63) Continuation of application No. PCT/JP2020/037793, filed on Oct. 6, 2020.

(30) Foreign Application Priority Data
Oct. 18, 2019 (JP) 2019-191048

(51) Int. Cl. G06F 3/044

(52) U.S. Cl. CPC G06F 3/0446; G06F 2203/04111

(57) ABSTRACT

A transparent laminate has in order: a first transparent resin layer; a transparent conductive layer; and a second transparent resin layer, and further has a third transparent resin layer having a higher refractive index than the first and second transparent resin layers at least one of between the first transparent resin layer and the transparent conductive layer, or between the transparent conductive layer and the second transparent resin layer, and a thickness T of the transparent conductive layer satisfies a relationship represented by Expression (1), {(n×550/4)−50} nm≤T≤{(n×550/4)+50} nm, where n represents an integer of 1 or more.

### CROSS-REFERENCE TO RELATED APPLICATIONS

This application is a Continuation of PCT International Application No. PCT/JP2020/037793 filed on Oct. 6, 2020, which claims priority under 35 U.S.C § 119(a) to Japanese Patent Application No. 2019-191048 filed on Oct. 18, 2019. Each of the above application(s) is hereby expressly incorporated by reference, in its entirety, into the present application.

### BACKGROUND OF THE INVENTION

### 1. Field of the Invention

The present invention relates to a transparent laminate and an image display apparatus.

### 2. Description of the Related Art

A transparent conductive layer consisting of indium-doped tin oxide (ITO) or the like is used for various purposes. For example, the transparent conductive layer is used as a transparent electrode layer for use in a capacitance type touch panel, an electromagnetic wave shielding layer, or the like.

JP2014-10814A discloses a transparent laminate having: a transparent resin layer having a predetermined refractive index; and a transparent electrode pattern functioning as a transparent conductive layer.

### SUMMARY OF THE INVENTION

A transparent laminate including a transparent conductive layer is required to have a reduced reflectivity. For example, in a case where the transparent laminate applied to a touch sensor has a high reflectivity, an external light source and surrounding landscapes are likely to be reflected glare on a display surface.

The inventors have conducted studies on the reflectivity of the transparent laminate described in JP2014-10814A, and found that it does not meet the level required these days and that further improvement is required.

In addition, the transparent conductive layer included in the transparent laminate is desired to have excellent conductivity from the viewpoint of application to various applications (particularly, the viewpoint of application to a touch sensor).

An object of the present invention is to provide a transparent laminate which has a low reflectivity and is excellent in conductivity of a transparent conductive layer.

Another object of the present invention is to provide an image display apparatus including the transparent laminate.

The inventors have conducted intensive studies on the objects, and as a result, found that the objects can be achieved by the following configurations.

(1) A transparent laminate having in order: a first transparent resin layer; a transparent conductive layer; and a second transparent resin layer, in which a third transparent resin layer having a higher refractive index than the first and second transparent resin layers is provided at least one of between the first transparent resin layer and the transparent conductive layer, or between the transparent conductive layer and the second transparent resin layer, and a thickness T of the transparent conductive layer satisfies a relationship represented by Expression (1).

{(n×550/4)−50} nm≤T≤{(n×550/4)+50} nm Expression (1)

n represents an integer of 1 or more.

(2) The transparent laminate according to (1), in which the third transparent resin layer has a refractive index equal to or greater than 1.60.

(3) The transparent laminate according to (1) or (2), in which the third transparent resin layer has a thickness equal to or less than 200 nm.

(4) The transparent laminate according to any one of (1) to (3), in which n is 1 in Expression (1).

(5) The transparent laminate according to any one of (1) to (4), in which the transparent conductive layer has a thickness of 100 to 160 nm.

(6) The transparent laminate according to any one of (1) to (5), in which the third transparent resin layer is provided both between the first transparent resin layer and the transparent conductive layer and between the transparent conductive layer and the second transparent resin layer.

(7) The transparent laminate according to any one of (1) to (6), in which a fourth transparent resin layer having a lower refractive index than the third transparent resin layer is further provided between the transparent conductive layer and the third transparent resin layer.

(8) The transparent laminate according to any one of (1) to (7), in which the third transparent resin layer contains metal oxide particles.

(9) The transparent laminate according to any one of (1) to (8), in which the transparent laminate is used as a touch sensor.

(10) An image display apparatus having: an image display element; and the transparent laminate according to (9).

According to the present invention, it is possible to provide a transparent laminate which has a low reflectivity and is excellent in conductivity of a transparent conductive layer.

In addition, according to the present invention, it is possible to provide an image display apparatus including the transparent laminate.

### BRIEF DESCRIPTION OF THE DRAWINGS

FIG. 1 is a cross-sectional view of a first embodiment of a transparent laminate.

FIG. 2 is a cross-sectional view of a second embodiment of the transparent laminate.

FIG. 3 is a cross-sectional view of a third embodiment of the transparent laminate.

FIG. 4 is a cross-sectional view of a fourth embodiment of the transparent laminate.

FIG. 5 is a partial cross-sectional view of a fifth embodiment of the transparent laminate.

FIG. 6 is a plan view of the transparent laminate for illustrating a first electrode pattern and a second electrode pattern in the transparent laminate.

### DESCRIPTION OF THE PREFERRED EMBODIMENTS

Hereinafter, the present invention will be described in detail.

In this specification, a numerical range expressed using “to” means a range including numerical values before and after “to” as a lower limit and an upper limit.

In addition, in numerical ranges described in a stepwise manner in this specification, an upper limit or a lower limit described in a certain numerical range may be replaced with an upper limit or a lower limit in another numerical range described in a stepwise manner. In addition, in a numerical range described in this specification, an upper limit or a lower limit described in a certain numerical range may be replaced with a value shown in an example.

In this specification, the term “step” includes not only an independent step but also cases where it cannot be clearly distinguished from other steps, so long as the desired effect of the step can be achieved.

In this specification, “transparent” means that the average transmittance of visible light having a wavelength of 400 to 700 nm is equal to or greater than 80%, and is preferably equal to or greater than 90%. Accordingly, for example, “transparent resin layer” refers to a resin layer in which the average transmittance of visible light having a wavelength of 400 to 700 nm is equal to or greater than 80%.

The average transmittance of visible light is a value measured using a spectrophotometer, and can be measured using, for example, a spectrophotometer U-3310 manufactured by Hitachi, Ltd.

In this specification, unless otherwise specified, the content ratio of each structural unit of a polymer is a molar ratio.

In addition, in this specification, the refractive index is a value measured by an ellipsometer at a wavelength of 550 nm unless otherwise specified.

In this specification, “(meth)acrylic acid” is a concept including both an acrylic acid and a methacrylic acid, and “(meth)acryloyl group” is a concept including both an acryloyl group and a methacryloyl group.

A feature point of a transparent laminate according to an embodiment of the present invention is that a third transparent resin layer to be described later is used and the thickness of a transparent conductive layer is adjusted to a predetermined thickness. The inventors have found that by adopting the above configuration, the reflectivity of the transparent laminate can be reduced and the transparent conductive layer included in the transparent laminate has excellent conductivity.

### First Embodiment

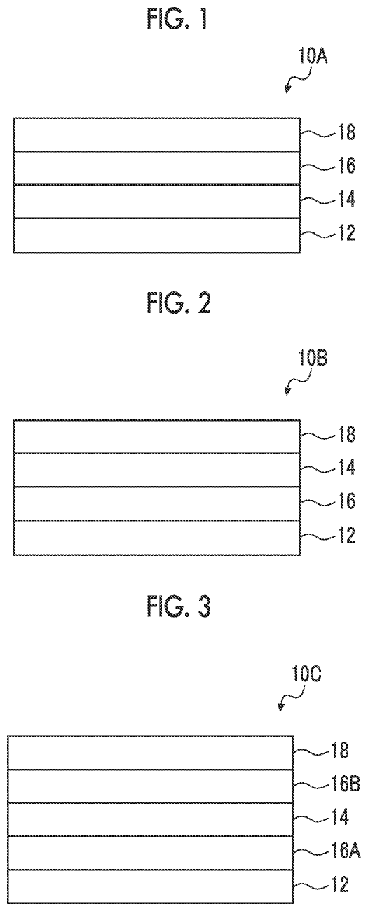

FIG. 1 is a cross-sectional view of a first embodiment of the transparent laminate.

A transparent laminate 10A has a first transparent resin layer 12, a transparent conductive layer 14, a third transparent resin layer 16, and a second transparent resin layer 18 in this order. The third transparent resin layer 16 is placed between the transparent conductive layer 14 and the second transparent resin layer 18.

Hereinafter, the respective members constituting the transparent laminate 10A will be described in detail.

<First Transparent Resin Layer>

The first transparent resin layer is a layer placed on one surface side of the transparent conductive layer.

The refractive index of the first transparent resin layer is not particularly limited as long as the relationship with the third transparent resin layer to be described later is satisfied. From the viewpoint that at least one effect out of a further reduction in reflectivity of the laminate or a further improvement in conductivity of the transparent conductive layer is obtained (hereinafter, also simply referred to as “from the viewpoint that the effects of the present invention are further improved”), the refractive index of the first transparent resin layer is preferably less than 1.60, more preferably equal to or greater than 1.40 and less than 1.60, and even more preferably 1.45 to 1.55.

The thickness of the first transparent resin layer is not particularly limited, and is preferably equal to or greater than 0.5 μm, more preferably 0.5 to 50 μm, even more preferably 0.5 to 20 μm, and particularly preferably 1 to 10 μm from the viewpoint that the effects of the present invention are further improved.

The thickness of the first transparent resin layer is an average thickness measured using a scanning electron microscope (SEM). Specifically, a slice of the transparent laminate is formed using an ultramicrotome, the thicknesses of the first transparent resin layer is measured at five optional points, and the results are arithmetically averaged to define an average thickness.

The components contained in the first transparent resin layer are not particularly limited, and a resin is usually contained.

In addition, the first transparent resin layer is preferably a cured product of a composition containing an alkali-soluble resin, a polymerizable monomer, and a polymerization initiator.

As will be described later, the first transparent resin layer is preferably a cured layer formed by a curing reaction of a curing component (for example, a polymerizable monomer) in a first transparent transfer layer.

Details of the components forming the first transparent resin layer, including the alkali-soluble resin, the polymerizable monomer, and the polymerization initiator, will be given through the description of the first transparent transfer layer to be provided later.

<Transparent Conductive Layer>

The transparent conductive layer is a layer placed on at least one surface side of the first transparent resin layer described above.

A thickness T (nm) of the transparent conductive layer satisfies a relationship represented by Expression (1). n represents an integer of 1 or more.

{(n×550/4)−50} nm≤T≤{(n×550/4)+50} nm Expression (1)

For example, in a case where n is 1, the thickness T of the transparent conductive layer satisfies a relationship represented by Expression (1-1).

87.5 nm≤T≤187.5 nm Expression (1-1)

In addition, in a case where n is 2, the thickness T of the transparent conductive layer satisfies a relationship represented by Expression (1-2).

225 nm≤T≤325 nm Expression (1-2)

n represents an integer of 1 or more. The upper limit thereof is not particularly limited, and in many cases, the upper limit is an integer of 5 or less.

From the viewpoint that the effects of the present invention are further improved and that in a case where the transparent conductive layer is a patterned layer, the patterned transparent conductive layer is difficult to be visually recognized, n is preferably 1.

From the viewpoint that the effects of the present invention are further improved and that in a case where the transparent conductive layer is a patterned layer, the patterned transparent conductive layer is difficult to be visually recognized, the thickness T of the transparent conductive layer is preferably 100 to 160 nm.

The thickness T of the transparent conductive layer is an average thickness measured using a transmission electron microscope (TEM). Specifically, a slice of the transparent laminate is formed using an ultramicrotome, the thicknesses of the transparent conductive layer is measured at five optional points, and the results are arithmetically averaged to define an average thickness.

The refractive index of the transparent conductive layer is not particularly limited, and is preferably equal to or greater than 1.70, more preferably 1.70 to 2.30, and even more preferably 1.80 to 2.10 from the viewpoint that the effects of the present invention are further improved.

The material constituting the transparent conductive layer may be a material capable of forming the transparent conductive layer, and known materials can be used. Examples thereof include metal oxides such as indium tin oxide (ITO), zinc aluminum oxide (AZO), and indium zinc oxide (IZO).

In FIG. 1, the transparent conductive layer is placed on the whole surface of the first transparent resin layer. The present invention is not limited to this aspect, and the transparent conductive layer may be placed in a pattern.

<Third Transparent Resin Layer>

The third transparent resin layer is a layer having a refractive index higher than that of the first transparent resin layer and that of the second transparent resin layer to be described later.

The refractive index of the third transparent resin layer is not particularly limited as long as it is higher than that of the first transparent resin layer and that of the second transparent resin layer, and in many cases, the refractive index of the third transparent resin layer is equal to or greater than 1.55. In a case where the transparent conductive layer is a patterned layer, the refractive index is preferably equal to or greater than 1.60, more preferably equal to or greater than 1.65, and even more preferably equal to or greater than 1.68 from the viewpoint that the patterned transparent conductive layer is difficult to be visually recognized. The upper limit thereof is not particularly limited, and is preferably equal to or less than 1.90, more preferably equal to or less than 1.85, and even more preferably equal to or less than 1.80.

The difference between the refractive index of the third transparent resin layer and the refractive index of the first transparent resin layer is not particularly limited, and is preferably equal to or greater than 0.01, more preferably equal to or greater than 0.10, and even more preferably equal to or greater than 0.15 from the viewpoint that the effects of the present invention are further improved. The upper limit thereof is not particularly limited, and in many cases, the upper limit is equal to or less than 0.50.

The difference between the refractive index of the third transparent resin layer and the refractive index of the second transparent resin layer is not particularly limited, and is preferably equal to or greater than 0.01, more preferably equal to or greater than 0.10, and even more preferably equal to or greater than 0.15 from the viewpoint that the effects of the present invention are further improved. The upper limit thereof is not particularly limited, and in many cases, the upper limit is equal to or less than 0.50.

The thickness of the third transparent resin layer is not particularly limited, and in many cases, the thickness of the third transparent resin layer is equal to or less than 300 nm. From the viewpoint that the effects of the present invention are further improved and that in a case where the transparent conductive layer is a patterned layer, the patterned transparent conductive layer is difficult to be visually recognized, the thickness is preferably equal to or less than 200 nm, more preferably 20 to 200 nm, even more preferably 40 to 200 nm, and particularly preferably 50 to 100 nm.

The thickness of the third transparent resin layer is an average thickness measured using a transmission electron microscope, and can be measured according to the same procedure as in the above-described method of measuring the thickness of the transparent conductive layer.

The components contained in the third transparent resin layer are not particularly limited, and a resin is usually contained.

The third transparent resin layer preferably contains metal oxide particles from the viewpoint that the effects of the present invention are further improved.

In addition, the third transparent resin layer is preferably a cured product of a composition containing an alkali-soluble resin, a polymerizable monomer, metal oxide particles, and a polymerization initiator.

As will be described later, the third transparent resin layer is preferably a cured layer formed by a curing reaction of a curing component (for example, a polymerizable monomer) in a third transparent transfer layer.

Details of the components forming the third transparent resin layer, including the alkali-soluble resin, the polymerizable monomer, the metal oxide particles, and the polymerization initiator, will be given through the description of the third transparent transfer layer to be provided later.

<Second Transparent Resin Layer>

The second transparent resin layer is a layer placed on the side opposite to the transparent conductive layer side of the third transparent resin layer.

The refractive index of the second transparent resin layer is not particularly limited as long as the relationship with the third transparent resin layer described above is satisfied. From the viewpoint that the effects of the present invention are further improved, the refractive index of the second transparent resin layer is preferably less than 1.60, more preferably equal to or greater than 1.40 and less than 1.60, and even more preferably 1.45 to 1.55.

The thickness of the second transparent resin layer is not particularly limited, and is preferably equal to or greater than 0.5 μm, more preferably 0.5 to 50 μm, even more preferably 0.5 to 20 μm, and particularly preferably 1 to 10 μm from the viewpoint that the effects of the present invention are further improved.

The thickness of the second transparent resin layer is an average thickness measured using a scanning electron microscope, and can be measured according to the same procedure as in the above-described method of measuring the thickness of the first transparent resin layer.

The components contained in the second transparent resin layer are not particularly limited, and a resin is usually contained.

In addition, the second transparent resin layer is preferably a cured product of a composition containing an alkali-soluble resin, a polymerizable monomer, and a polymerization initiator.

As will be described later, the second transparent resin layer is preferably a cured layer formed by a curing reaction of a curing component (for example, a polymerizable monomer) in a second transparent transfer layer.

Details of the components forming the second transparent resin layer, including the alkali-soluble resin, the polymerizable monomer, and the polymerization initiator, will be given through the description of the second transparent transfer layer to be provided later.

The transparent laminate 10A shown in FIG. 1 may include a member other than the first transparent resin layer 12, the transparent conductive layer 14, the third transparent resin layer 16, and the second transparent resin layer 18 described above.

<Method of Manufacturing Transparent Laminate>

The method of manufacturing the transparent laminate 10A shown in FIG. 1 is not particularly limited, and a known method can be adopted.

Examples thereof include a method using a transfer film having a transparent transfer layer capable of forming each transparent resin layer. More specifically, a method of manufacturing a transparent laminate having the following steps 1 to 4 can be adopted.

Step 1: a step of transferring a first transparent transfer layer onto a substrate by using a first transfer film, in which the first transparent transfer layer to be a first transparent resin layer after transfer is provided on a temporary support, to form the first transparent resin layer

Step 2: a step of forming a transparent conductive layer on the first transparent resin layer

Step 3: a step of transferring a third transparent transfer layer onto the transparent conductive layer by using a third transfer film, in which the third transparent transfer layer to be a third transparent resin layer after transfer is provided on a temporary support, to form the third transparent resin layer

Step 4: a step of transferring a second transparent transfer layer onto the third transparent transfer layer by using a second transfer film, in which the second transparent transfer layer to be a second transparent resin layer after transfer is provided on a temporary support, to form the second transparent resin layer

In the above steps, each transparent resin layer is transferred, but for example, instead of the steps 3 and 4, a transfer treatment using a transfer film in which a second transparent transfer layer and a third transparent transfer layer are provided in this order on a temporary support can be performed so that the third transparent transfer layer and the second transparent transfer layer can be transferred onto the transparent conductive layer.

Hereinafter, the respective members of the transfer film will be described in detail.

(Temporary Support)

The material of the temporary support is not particularly limited as long as it has required hardness and flexibility. A resin film is preferable from the viewpoint of moldability and cost.

Examples of the temporary support include a polyethylene terephthalate film, a cellulose triacetate film, a polystyrene film, and a polycarbonate film.

(First Transparent Transfer Layer)

The first transparent transfer layer is a layer which can be the first transparent resin layer after transfer.

The first transparent transfer layer may be, for example, a layer containing at least a polymerizable monomer and a resin, or a layer which is cured by applying energy. The first transparent transfer layer may further contain a polymerization initiator or a compound which can react with an acid by heating.

The first transparent transfer layer may have photocuring properties, thermosetting properties, or thermosetting properties and photocuring properties.

The thickness of the first transparent transfer layer is not particularly limited, and is adjusted to be the thickness of the first transparent resin layer described above.

The first transparent transfer layer preferably contains a resin. The resin can function as a binder. As the resin, an alkali-soluble resin is preferable.

The alkali-soluble resin is a linear organic high molecular weight polymer, and can be appropriately selected from polymers having at least one group accelerating alkali solubility in the molecule. Examples of the group accelerating alkali solubility, that is, the acid group include a carboxyl group, a phosphoric acid group, and a sulfonic acid group, and a carboxyl group is preferable.

The alkali-soluble resin is preferably a resin having an acid value equal to or greater than 60 mgKOH/g from the viewpoint of developability. The acid value is preferably 60 to 200 mgKOH/g, and more preferably 60 to 150 mgKOH/g.

In this specification, the acid value of a resin is a value measured using a titration method specified in JIS K0070 (1992).

The weight-average molecular weight of the alkali-soluble resin is preferably equal to or greater than 5,000, and more preferably equal to or greater than 10,000. The upper limit of the weight-average molecular weight of the alkali-soluble resin is not particularly limited, and may be 100,000.

In addition, the alkali-soluble resin is preferably a resin having a carboxyl group since the resin reacts with a crosslinking component to thermally cross-link and is likely to form a strong film.

The alkali-soluble resin is preferably a (meth)acrylic resin from the viewpoint of developability and transparency. The (meth)acrylic resin is a resin having a constitutional unit derived from at least one of (meth)acrylic acid or (meth)acrylic acid ester.

The content of the alkali-soluble resin is not particularly limited, and is preferably 1 to 80 mass %, and more preferably 5 to 60 mass % with respect to the total mass of the first transparent transfer layer.

The resins may be used alone or in combination of two or more kinds.

The first transparent transfer layer preferably contains a polymerizable monomer.

The polymerizable monomer is preferably a polymerizable monomer having an ethylenically unsaturated group, and more preferably a photopolymerizable compound having an ethylenically unsaturated group. The polymerizable monomer preferably has at least one ethylenically unsaturated group as a photopolymerizable group, and may have a cationically polymerizable group such as an epoxy group in addition to the ethylenically unsaturated group. The polymerizable monomer is preferably a compound having a (meth)acryloyl group.

The polymerizable monomer is preferably a polyfunctional polymerizable monomer having two or more ethylenically unsaturated groups. The polyfunctional polymerizable monomer is preferably a compound having two ethylenically unsaturated groups or a compound having at least three ethylenically unsaturated groups, and more preferably a compound having two (meth)acryloyl groups or a compound having at least three (meth)acryloyl groups.

In addition, at least one kind of the polymerizable monomer preferably contains a carboxyl group since the carboxyl group in the resin and the carboxyl group in the polymerizable monomer form a carboxyl acid anhydride, thereby enhancing moisture-heat resistance.

The molecular weight of the polymerizable monomer is preferably 200 to 3,000, more preferably 250 to 2,600, and even more preferably 280 to 2,200.

The content of the polymerizable monomer is not particularly limited, and is preferably 1 to 50 mass %, and more preferably 2 to 40 mass % with respect to the total mass of the first transparent transfer layer.

In a case where a polyfunctional polymerizable monomer is used, the content of the polyfunctional polymerizable monomer with respect to the total mass of all the polymerizable monomers contained in the first transparent transfer layer is preferably 10 to 90 mass %, and more preferably 20 to 85 mass %.

The polymerizable monomer may be used alone or in combination of two or more kinds.

The polymerizable monomer preferably includes a compound having two ethylenically unsaturated groups and a compound having three or more ethylenically unsaturated groups.

The first transparent transfer layer preferably contains a polymerization initiator.

The polymerization initiator is preferably a photopolymerization initiator.

The photopolymerization initiator preferably includes at least one selected from the group consisting of an oxime-based photopolymerization initiator, an alkylphenone-based photopolymerization initiator, and a thioxanthene-based photopolymerization initiator.

In a case where the first transparent transfer layer contains a polymerization initiator, the content of the polymerization initiator with respect to the total mass of the first transparent transfer layer is preferably 0.01 to 10 mass %, and more preferably 0.05 to 5 mass %.

The polymerization initiators may be used alone or in combination of two or more kinds.

The photopolymerization initiator preferably includes an oxime-based photopolymerization initiator and an alkylphenone-based photopolymerization initiator. The photopolymerization initiator also preferably includes an alkylphenone-based photopolymerization initiator and a thioxanthene-based photopolymerization initiator.

The first transparent transfer layer may contain a component other than the components described above.

Examples of other components include a sensitizer, a polymerization inhibitor, a compound which can react with an acid by heating, a surfactant, and particles.

The first transparent transfer layer can be formed by coating a solution obtained by dissolving the above-described various components in a solvent onto a temporary support and drying the solution.

(Second Transparent Transfer Layer)

Since the components constituting the second transparent transfer layer are the same as the above-described components (resin, polymerizable monomer, polymerization initiator, and the like) constituting the first transparent transfer layer, description thereof will be omitted.

(Third Transparent Transfer Layer)

The third transparent transfer layer may contain the above-described components (resin, polymerizable monomer, polymerization initiator, and the like) constituting the first transparent transfer layer.

In addition, the third transparent transfer layer preferably contains metal oxide particles. In a case where the third transparent transfer layer contains metal oxide particles, the refractive index and the light transmittance can be adjusted.

The type of the metal oxide particles is not particularly limited, and known metal oxide particles can be used. The third transparent transfer layer preferably contains at least one of zirconium oxide particles (ZrO₂ particles), Nb₂O₅ particles, titanium oxide particles (TiO₂ particles), or silicon dioxide particles (SiO₂ particles) from the viewpoint of transparency and from the viewpoint that the refractive index is easily controlled within the range of the refractive index of the third transparent resin layer. From the viewpoint that the refractive index of the third transparent resin layer is easily adjusted to 1.60 or greater, zirconium oxide particles or titanium oxide particles are more preferable, and zirconium oxide particles are even more preferable.

The average primary particle diameter of the metal oxide particles is preferably equal to or less than 100 nm, more preferably equal to or less than 50 nm, and even more preferably equal to or less than 20 nm from the viewpoint of optical performance such as haze.

The average primary particle diameter of the metal oxide particles is a value obtained by measuring diameters of 100 optional particles by observation with a transmission electron microscope and arithmetically averaging the 100 diameters. In a case where the metal oxide particles are not completely round, the major axis serves as the diameter.

Examples of commercially available metal oxide particles include calcined zirconium oxide particles (manufactured by CIK NanoTek Corporation, product name: ZRPGM15 WT %-F04), calcined zirconium oxide particles (manufactured by CIK NanoTek Corporation, product name: ZRPGM15 WT %-F74), calcined zirconium oxide particles (manufactured by CIK NanoTek Corporation, product name: ZRPGM15 WT %-F75), calcined zirconium oxide particles (manufactured by CIK NanoTek Corporation, product name: ZRPGM15 WT %-F76), zirconium oxide particles (NANOUSE OZ-S30M, manufactured by Nissan Chemical Corporation), and zirconium oxide particles (NANOUSE OZ-S30K, manufactured by Nissan Chemical Corporation). The content of the metal oxide particles in the third transparent transfer layer is not particularly limited, and is preferably 1 to 95 mass %, and more preferably 20 to 90 mass % with respect to the total mass of the third transparent transfer layer from the viewpoint that the effects of the present invention are further improved.

The metal oxide particles may be used alone or in combination of two or more kinds.

The third transparent transfer layer may contain a metal oxidation inhibitor other than the components described above. The metal oxidation inhibitor is preferably a compound having an aromatic ring containing a nitrogen atom in the molecule.

In addition, the aromatic ring containing a nitrogen atom contained in the metal oxidation inhibitor is preferably at least one selected from the group consisting of an imidazole ring, a triazole ring, a tetrazole ring, a thiadiazole ring, and a fused ring of the above ring and another aromatic ring.

In a case where the above-described first to third transparent transfer layers contain a polymerizable monomer, the first to third transparent resin layers can be manufactured by subjecting the respective transparent transfer layers to a light irradiation treatment.

During the light irradiation, light may be applied in a pattern as needed. In addition, in a case where light is applied in a pattern, a development treatment (for example, an alkaline development treatment) may be performed as needed.

In addition, in the formation of through holes which will be described in a fifth embodiment to be described later, the through holes can be formed by patterning in which light is applied through a mask for forming desired through holes on the first transparent transfer layer.

### Second Embodiment

FIG. 2 is a cross-sectional view of a second embodiment of the transparent laminate.

A transparent laminate 10B has a first transparent resin layer 12, a third transparent resin layer 16, a transparent conductive layer 14, and a second transparent resin layer 18 in this order. The third transparent resin layer 16 is placed between the first transparent resin layer 12 and the transparent conductive layer 14.

The second embodiment of the transparent laminate has the same configuration as the first embodiment of the transparent laminate described above, except that the positions of the transparent conductive layer 14 and the third transparent resin layer 16 are different. The same members are denoted by the same reference numerals, and description thereof will be omitted.

### Third Embodiment

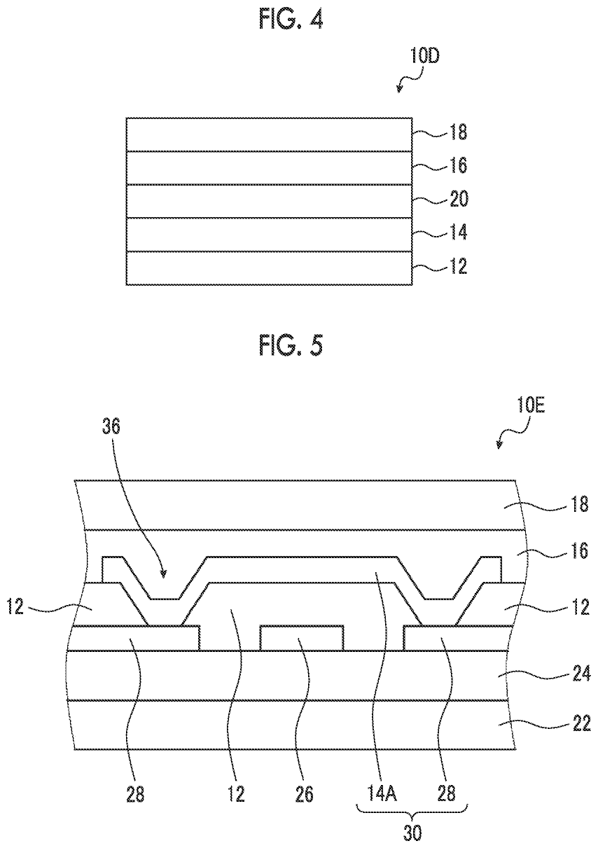

FIG. 3 is a cross-sectional view of a third embodiment of the transparent laminate.

A transparent laminate 10C has a first transparent resin layer 12, a third transparent resin layer 16A, a transparent conductive layer 14, a third transparent resin layer 16B, and a second transparent resin layer 18 in this order. In the transparent laminate 10C, the third transparent resin layers (16A and 16B) are placed both between the first transparent resin layer 12 and the transparent conductive layer 14 and between the transparent conductive layer 14 and the second transparent resin layer 18, respectively. In the transparent laminate 10C, the reflectivity is further reduced.

The third embodiment of the transparent laminate has the same configuration as the first embodiment of the transparent laminate described above, except that the two third transparent resin layers (16A and 16B) are provided. The same members are denoted by the same reference numerals, and description thereof will be omitted.

The third transparent resin layers 16A and 16B are members having the same configuration as the third transparent resin layer 16 described in the first embodiment of the transparent laminate.

### Fourth Embodiment

FIG. 4 is a cross-sectional view of a fourth embodiment of the transparent laminate.

A transparent laminate 10D has a first transparent resin layer 12, a transparent conductive layer 14, a fourth transparent resin layer 20, a third transparent resin layer 16, and a second transparent resin layer 18 in this order.

The fourth embodiment of the transparent laminate has the same configuration as the first embodiment of the transparent laminate described above, except that the fourth transparent resin layer 20 is provided. The same members are denoted by the same reference numerals, and description thereof will be omitted.

The fourth transparent resin layer is a transparent resin layer having a lower refractive index than the third transparent resin layer.

The refractive index of the fourth transparent resin layer is not particularly limited as long as the relationship with the third transparent resin layer to be described later is satisfied. From the viewpoint that the effects of the present invention are further improved, the refractive index of the fourth transparent resin layer is preferably less than 1.60, more preferably equal to or greater than 1.40 and less than 1.60, and even more preferably 1.45 to 1.55.

The thickness of the fourth transparent resin layer is not particularly limited, and is preferably 5 to 200 nm, and more preferably 10 to 100 nm from the viewpoint that the effects of the present invention are further improved.

The thickness of the fourth transparent resin layer is an average thickness measured using a transmission electron microscope, and can be measured according to the same procedure as in the above-described method of measuring the thickness of the transparent conductive layer.

The components contained in the fourth transparent resin layer are not particularly limited, and a resin is usually contained.

In addition, the fourth transparent resin layer is preferably a cured product of a composition containing an alkali-soluble resin, a polymerizable monomer, and a polymerization initiator.

The fourth transparent resin layer is preferably a cured layer formed by a curing reaction of a curing component in the fourth transparent transfer layer containing an alkali-soluble resin, a polymerizable monomer, and a polymerization initiator. That is, similarly to the first transparent resin layer and the like, the fourth transparent resin layer can be formed using a transfer film having a temporary support and the fourth transparent transfer layer which can be the fourth transparent resin layer placed on the temporary support.

Examples of the various components contained in the fourth transparent transfer layer include the various components contained in the first transparent transfer layer described above.

### Fifth Embodiment

FIG. 5 is a partial cross-sectional view of a fifth embodiment of the transparent laminate.

A transparent laminate 10E has a transparent substrate 22, a transparent layer 24, a first electrode pattern 26, a first transparent resin layer 12, a second electrode pattern 30 including a transparent conductive layer 14A and a second island-shaped electrode portion 28, a third transparent resin layer 16, and a second transparent resin layer 18.

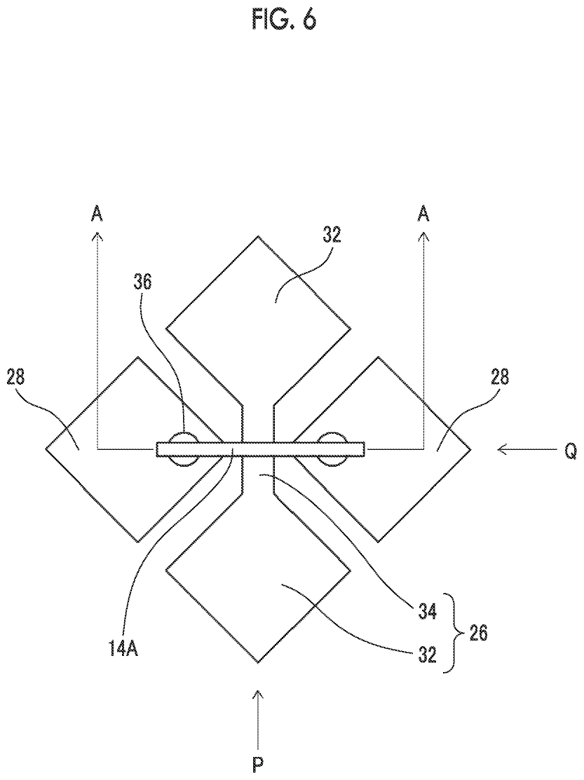

FIG. 6 is a plan view showing a configuration of the first electrode pattern 26 and the second electrode pattern 30 in the transparent laminate 10E, and FIG. 5 is a cross-sectional view taken along the line A-A in FIG. 6.

As shown in FIG. 6, the transparent laminate 10E has the first electrode pattern 26 and the second electrode pattern 30 extending in a direction of the arrow P and in a direction of the arrow Q, respectively, the directions intersecting each other.

As shown in FIGS. 5 and 6, the first electrode pattern 26 is composed of a plurality of first island-shaped electrode portions 32 arranged in a first direction (direction of the arrow P), and a wiring portion 34 connecting the adjacent first island-shaped electrode portions 32. That is, in the transparent laminate 10E, an electrode which is long in one direction is formed above the transparent substrate 22. Although only one first electrode pattern 26 is shown in FIGS. 5 and 6, a plurality of first electrode patterns may be placed at predetermined intervals along a direction orthogonal to the first direction.

In addition, as shown in FIGS. 5 and 6, the second electrode pattern 30 is composed of a plurality of second island-shaped electrode portions 28 arranged in another direction (direction of the arrow Q) orthogonal to the first direction, and a transparent conductive layer 14A which builds a bridge between the adjacent second island-shaped electrode portions 28 so as to straddle the first electrode pattern 26. That is, in the transparent laminate 10E, an electrode which is long in the direction orthogonal to the first electrode pattern is formed above the transparent substrate 22. Although only one second electrode pattern 30 is shown in FIGS. 5 and 6, a plurality of second electrode patterns may be placed at predetermined intervals along the first direction.

As shown in FIG. 5, the first electrode pattern 26 and the second electrode pattern 30 form a bridge structure, in which one of the intersecting electrodes jumps over the other so as to prevent both patterns from being electrically connected to each other, in an intersecting portion.

In addition, the transparent conductive layer 14A is connected to the second island-shaped electrode portion 28 through a through hole 36 provided in the first transparent resin layer 12. That is, through the through hole 36, the transparent conductive layer (bridge wiring electrode) 14A is connected to the second island-shaped electrode portion 28 exposed in the through hole 36, and builds a bridge between the adjacent second island-shaped electrode portions 28 so as to straddle the wiring portion 34, whereby the second island-shaped electrode portions 28 are electrically connected to each other.

As described above, the transparent laminate 10E has the first electrode pattern 26 and the second electrode pattern 30 extending in directions intersecting each other, respectively, on one surface side of the transparent substrate 22. The first electrode pattern 26 has a plurality of the first island-shaped electrode portions 32 placed at intervals in the first direction and the wiring portion 34 which electrically connects the adjacent first island-shaped electrode portions 32, and the second electrode pattern 30 has a plurality of the second island-shaped electrode portions 28 placed at intervals in the second direction intersecting the first direction and the transparent conductive layer 14A which builds a bridge between and electrically connects the adjacent second island-shaped electrode portions 28 so as to straddle the first electrode pattern 26. The first transparent resin layer 12 is placed on the side of the transparent conductive layer 14A where the transparent substrate 22 is placed (the first transparent resin layer 12 is placed between the transparent conductive layer 14A and the first electrode pattern 26), and the third transparent resin layer 16 and the second transparent resin layer 18 are provided in this order on the side of the transparent conductive layer 14A opposite to the transparent substrate 22.

As described above, the transparent laminate 10E includes the first transparent resin layer 12, the transparent conductive layer 14A which functions as a bridge wiring electrode building a bridge between the second island-shaped electrode portions 28, the third transparent resin layer 16, and the second transparent resin layer 18, and in a part where the above four members are placed, the transparent laminate has a reduced reflectivity and is excellent in conductivity of the transparent conductive layer 14A.

Hereinafter, the respective members included in the transparent laminate 10E will be described in detail.

<Transparent Substrate 22>

The transparent substrate is a member for supporting the above-described layers.

The transparent substrate is preferably a substrate having electrical insulating properties.

Examples of the substrate having electrical insulating properties include a glass substrate, a polyethylene terephthalate film, a polycarbonate film, a cycloolefin polymer film, and a polyvinyl chloride film.

A cycloolefin polymer film is preferable from the viewpoint that it is excellent not only in optical isotropy but also in dimensional stability and processing accuracy.

In a case where the transparent substrate is a glass substrate, the thickness thereof may be 0.3 to 3 mm. In addition, in a case where the transparent substrate is a resin film, the thickness thereof may be 20 μm to 3 mm

<Transparent Layer>

The transparent layer is a layer placed on the transparent substrate. The transparent layer is an optional layer which is provided as needed.

The transparent layer may be a transparent resin layer containing a resin.

The refractive index of the transparent layer is not particularly limited, and is preferably equal to or greater than 1.60, more preferably 1.60 to 1.90, even more preferably 1.60 to 1.70, and particularly preferably 1.60 to 1.65 from the viewpoint that the effects of the present invention are further improved.

The thickness of the transparent layer is preferably equal to or less than 200 nm, more preferably 40 to 200 nm, and even more preferably 50 to 100 nm.

The thickness of the transparent layer is an average thickness measured using a transmission electron microscope, and can be measured according to the same procedure as in the above-described method of measuring the thickness of the transparent conductive layer.

<First Electrode Pattern>

The first electrode pattern has a plurality of first island-shaped electrode portions placed at intervals in the first direction on the transparent layer and a wiring portion which electrically connects the adjacent first island-shaped electrode portions.

The refractive index of the first island-shaped electrode portion and the refractive index of the wiring portion are both preferably 1.75 to 2.10.

The first island-shaped electrode portion can be composed of, for example, a light transmitting metal oxide film such as an ITO film, an IZO film, and a SiO₂ film; a metal film such as Al, Zn, Cu, Fe, Ni, Cr, Mo, Ag, and Au; or a film of an alloy of a plurality of metals such as a copper-nickel alloy.

The thickness of the first island-shaped electrode portion is preferably 10 to 200 nm.

The shape of the first island-shaped electrode portion is not particularly limited, and may be any of a square, a rectangle, a rhombus, a trapezoid, a polygon with five or more sides, or the like. A square, a rhombus, or a hexagon is preferable from the viewpoint that a close-packed structure is easily formed.

The wiring portion is not limited as long as it is a member capable of electrically connecting the adjacent first island-shaped electrode portions to each other. The same material as the first island-shaped electrode portion can be applied to the wiring portion, and the same is true of the thickness.

<Second Electrode Pattern>

The second electrode pattern has a plurality of second island-shaped electrode portions placed at intervals in the second direction intersecting the first direction on the transparent layer and a transparent conductive layer 14A which builds a bridge between and electrically connects the adjacent second island-shaped electrode portions.

The refractive index of the second island-shaped electrode portion and the refractive index of the wiring portion are both preferably 1.75 to 2.10.

The second island-shaped electrode portion can be composed of, for example, a light transmitting metal oxide film such as an ITO film, an IZO film, and a SiO₂ film; a metal film such as Al, Zn, Cu, Fe, Ni, Cr, Mo, Ag, and Au; or a film of an alloy of a plurality of metals such as a copper-nickel alloy.

The thickness of the second island-shaped electrode portion is preferably 10 to 200 nm.

The shape of the second island-shaped electrode portion is not particularly limited, and may be any of a square, a rectangle, a rhombus, a trapezoid, a polygon with five or more sides, or the like. A square, a rhombus, or a hexagon is preferable from the viewpoint that a close-packed structure is easily formed.

The transparent conductive layer 14A is a member which builds a bridge between and electrically connects the adjacent second island-shaped electrode portions while straddling the first electrode pattern.

The characteristics (thickness, refractive index, material, and the like) of the transparent conductive layer 14A are the same as those of the transparent conductive layer 14 described in the above-described first embodiment, and description thereof will be omitted. That is, a thickness T of the transparent conductive layer 14A satisfies the relationship represented by Expression (1) described above.

The third transparent resin layer 16 and the second transparent resin layer 18 in the fifth embodiment are the same as the third transparent resin layer 16 and the second transparent resin layer 18 described in the above-described first embodiment, and description thereof will be omitted.

The fifth embodiment of the transparent laminate can be manufactured by a known method. For example, the first to third transparent resin layers can be formed using the above-described transfer film.

In addition, as the first and second electrode patterns, predetermined patterns can be formed by forming a conductive layer (for example, an ITO layer) constituting the above layers and subjecting the conductive layer to a known etching treatment.

<Use>

The transparent laminate according to the embodiment of the present invention can be applied to various uses. For example, the transparent laminate can be used for a touch sensor (preferably a capacitance type touch sensor) or an electromagnetic wave shield. In particular, the fifth embodiment of the transparent laminate can be suitably applied as a capacitance type touch sensor.

The present invention also relates to an image display apparatus including the transparent laminate.

The image display apparatus includes an image display element such as a liquid crystal display element and an organic electroluminescence display element, and the above-described transparent laminate used as a touch sensor.

### EXAMPLES

Hereinafter, the embodiments of the present invention will be described in more detail with reference to Examples. The embodiments of the present invention are not limited to the following Examples as long as the gist of the present invention is not exceeded. Unless otherwise specified, “part” and “%” are based on mass.

The compositional ratio in a polymer is a molar ratio unless otherwise specified.

In addition, unless otherwise specified, the refractive index is a value measured by an ellipsometer at a wavelength of 550 nm at 25° C.

Specifically, a value measured using a spectroscopic ellipsometer M-2000 (manufactured by J. A. Woollam) under the conditions of a measurement spot of 3 mmφ, a measurement wavelength of 250 to 1,000 nm, measurement angles of 60°, 65°, and 70°, and an integration number of 100 was used.

In the following Examples, the weight-average molecular weight of a resin was measured by gel permeation chromatography (GPC) under the following conditions. A calibration curve was created from 8 samples, “standard sample TSK standard, polystyrene” manufactured by Tosoh Corporation: “F-40”, “F-20”, “F-4”, “F-1”, “A-5000”, “A-2500”, “A-1000”, and “n-propylbenzene”.

(Conditions)

GPC: HLC (registered trademark)-8020GPC (manufactured by Tosoh Corporation)

Column: three TSKgel (registered trademark), Super Multipore HZ-H (Tosoh Corporation, 4.6 mm ID×15 cm) columns

Eluent: tetrahydrofuran

Sample Concentration: 0.45 mass %

Flow Rate: 0.35 ml/min

Amount of Sample Injected: 10 μl

Measurement Temperature: 40° C.

Detector: differential refractometer (RI)

<Preparation of Coating Liquid for Forming First Transparent Transfer Layer and Coating Liquid for Forming Second Transparent Transfer Layer>

Components were mixed according to the contents (parts by mass) of the respective components shown in the following Table 1, whereby coating liquids A-1 to A-6 as a coating liquid for forming a first transparent transfer layer and a coating liquid for forming a second transparent transfer layer were prepared.

The contents of the respective components in Table 1 are indicated by “parts by mass”.

TABLE 1

| | | Coating | Coating | Coating | Coating | Coating | Coating |
|---|---|---|---|---|---|---|---|
| | | Liquid | Liquid | Liquid | Liquid | Liquid | Liquid |
| Material | | A-1 | A-2 | A-3 | A-4 | A-5 | A-6 |
| Poly- | tricyclodecane dimethanol diacrylate (A-DCP manufactured by | 5.60 | — | 2.28 | — | — | — |
| merizable | SHIN-NAKAMURA CHEMICAL Co., Ltd.) | | | | | | |
| Monomer | carboxylic acid-containing monomer ARONIX TO-2349 (manufactured by | 0.93 | 0.93 | 0.76 | 0.93 | 0.88 | 0.88 |
| | TOAGOSEI CO., LTD.) | | | | | | |
| | urethane acrylate 8UX-015A (manufactured by Taisei Fine Chemical | 2.80 | — | — | — | — | — |
| | Co., Ltd.) | | | | | | |
| | DPHA liquid (dipentaerythritol hexacrylate: 38%, dipentaerythritol | — | 3.68 | 5.68 | 3.68 | 3.01 | 3.01 |
| | pentaacrylate: 38%, 1-methoxy-2-propyl acetate: 24%) | | | | | | |
| | A-NOD-N (manufactured by SHIN-NAKAMURA CHEMICAL Co., Ltd.) | — | 5.60 | 0.70 | 5.60 | 2.45 | 2.45 |
| | KAYARAD R-604 (manufactured by Nippon Kayaku Co., Ltd.) | — | — | — | — | 2.44 | 2.44 |
| Resin | the following compound A (acid value 95 mgKOH/g, Mw 29,000, Mn 13,700) | 15.59 | — | — | — | — | — |
| | the following compound B (acid value 95 mgKOH/g, Mw 17,000, Mn 8,000) | — | 15.59 | — | — | — | — |
| | the following compound C (acid value 124 mgKOH/g, Mw 17,000, Mn 8,000) | — | — | 12.26 | — | 12.40 | — |
| | the following compound D (acid value 114 mgKOH/g, Mw 17,000, Mn 8,000) | — | — | — | 15.59 | — | 15.59 |
| Poly- | ethanone, 1-9-ethyl-6-(2-methylbenzoyl)-9H-carbazol-3-yl]-, | 0.11 | — | 0.09 | — | — | — |
| merization | 1-(O-acetyloxime) (OXE-02, manufactured by BASF SE) | | | | | | |
| Initiator | 2-methyl-1-(4-methylthiophenyl)-2-morpholinopropan-1-one (Irgacure 907, | 0.21 | — | — | — | — | — |
| | manufactured by BASF SE) | | | | | | |
| | 1-(biphenyl-4-yl)-2-methyl-2-morpholinopropan-1-one (APi 307, manufactured | | — | 1.85 | 1.85 | 0.44 | 0.44 |
| | by Shenzhen UV-ChemTech LTD.) | | | | | | |
| | 2-benzyl-2-dimethylamino-1-(4-morpholinophenyl)-butanone (Irgacure 379, | — | 0.30 | — | 0.30 | 0.16 | 0.16 |
| | manufactured by BASF SE) | | | | | | |
| | KAYACURE DETX-S (manufactured by Nippon Kayaku Co., Ltd.) | — | 0.30 | — | — | — | — |
| Chain | N-phenylglycine (manufactured by Yodo Kagaku Co., Ltd.) | 0.03 | 0.03 | 0.03 | 0.03 | — | — |
| Transfer | | | | | | | |
| Agent | | | | | | | |
| Blocked | DURANATE WT32-B75P (manufactured by Asahi Kasei Corporation) | 3.63 | — | 4.17 | — | — | — |
| Isocyanate | AOI-BM (manufactured by Showa Denko K. K.) | — | 363 | — | 3.63 | — | — |
| | DURANATE SBN-70D (manufactured by Asahi Kasei Corporation) | — | — | — | — | 0.78 | — |
| | the following compound E | — | — | 0.74 | — | — | — |
| | the following compound F | — | — | — | 0.74 | — | — |
| Additive | MEGAFACE F551 (manufactured by DIC Corporation) | 0.02 | 0.02 | 0.16 | 0.16 | 0.24 | 0.02 |
| | 1,2,4-triazole (manufactured by Otsuka Chemical Co., Ltd.) | 0.09 | 0.09 | — | — | — | — |
| | benzimidazole (manufactured by Tokyo Chemical Industry Co., Ltd.) | — | — | 0.03 | — | 0.07 | 0.03 |
| | 5-amino-1H-tetrazole (manufactured by Tokyo Chemical Industry Co., Ltd.) | — | — | — | 0.03 | — | — |
| | isonicotinamide (manufactured by Tokyo Chemical Industry Co., Ltd.) | — | — | 0.01 | — | 0.22 | 0.01 |
| | SMAEF-40 (manufactured by TOMOEGAWA CO., LTD.) | — | — | 0.30 | 0.30 | — | 0.30 |
| | phenothiazine (manufactured by Tokyo Chemical Industry Co., Ltd.) | — | — | — | — | 0.02 | — |
| Solvent | 1-methoxy-2-propyl acetate | 31.08 | 30.00 | 30.00 | 30.00 | 30.00 | 30.00 |
| | methyl ethyl ketone | 40.00 | 39.91 | 40.94 | 37.16 | 46.89 | 44.66 |

Compound A: Mw=29,000, Mn=13,700

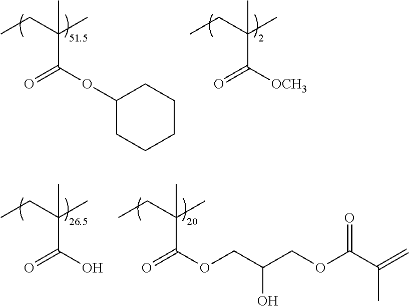

Compound B (See the Following Structural Formula): Mw=17,000, Mn=8,100

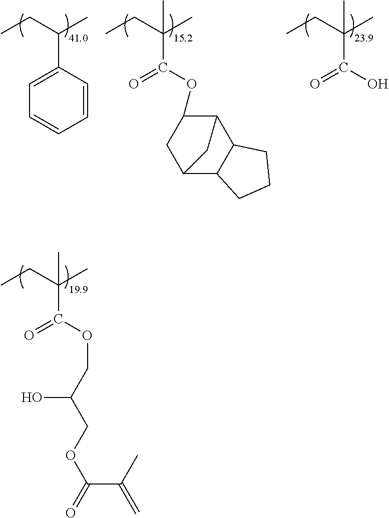

Compound C (See the Following Structural Formula): Mw=17,000, Mn=8,100

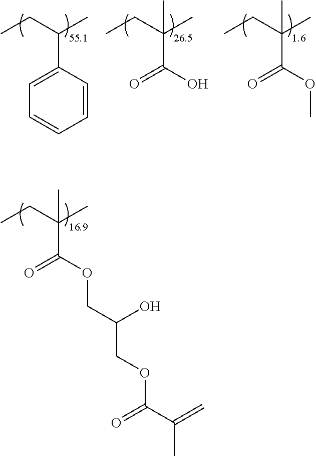

Compound D (See the Following Structural Formula): Mw=17,000, Mn=8,100

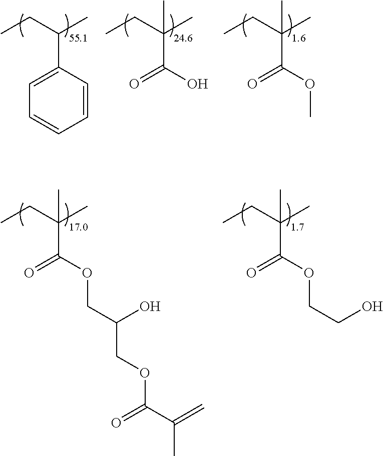

Compound E (See the Following Structural Formula)

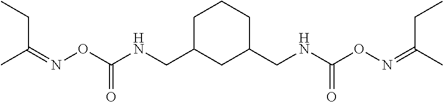 [SMILES: CC/C(C)=N\OC(=O)NCC1CCCC(CNC(=O)O/N=C(/C)CC)C1]

Compound F (See the Following Structural Formula)

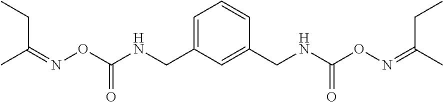 [SMILES: CC/C(C)=N\OC(=O)NCc1cccc(CNC(=O)O/N=C(/C)CC)c1]

<Preparation of Coating Liquid for Forming Third Transparent Transfer Layer and Coating Liquid for Forming Fourth Transparent Transfer Layer>

Components were mixed according to the contents (parts by mass) of the respective components shown in the following Table 2, whereby coating liquids B-1 to B-8 as a coating liquid for forming a third transparent transfer layer and a coating liquid for forming a fourth transparent transfer layer were prepared.

TABLE 2

| | | Coating | Coating | Coating | Coating | Coating | Coating | Coating | Coating |
|---|---|---|---|---|---|---|---|---|---|
| | | Liquid | Liquid | Liquid | Liquid | Liquid | Liquid | Liquid | Liquid |
| Material | | B-1 | B-2 | B-3 | B-4 | B-5 | B-6 | B-7 | B-8 |
| Nano Use OZ-S30M: ZrO2 particles•methanol dispersion (non-volatile | | 4.34 | — | 3.85 | 1.33 | — | — | 4.34 | 4.34 |
| content 30.5%) manufactured by Nissan Chemical Corporation | | | | | | | | | |
| colloidal silica SNOWTEX ST-N (non-volatile content 20%) | | — | — | — | — | — | 5.00 | — | — |
| manufactured by Nissan Chemical Corporation | | | | | | | | | |
| TS-020: aqueous dispersion of TiO2 particles (non-volatile content | | — | 3.50 | — | — | 6.00 | — | — | — |
| 25.6%) manufactured by TAYCA CORPORATION | | | | | | | | | |
| ammonia water (25%) | | 7.82 | 7.82 | 7.82 | 7.82 | 7.82 | 2.9 | 7.82 | 7.82 |
| monoisopropanolamine (manufactured by Mitsui Fine Chemicals, Inc.) | | 0.02 | 0.02 | 0.02 | 0.02 | 0.02 | 0.02 | 0.02 | 0.02 |
| Binder | copolymer resin of methacrylic acid and allyl methacrylate | 0.24 | 0.40 | 0.39 | 1.16 | 0.32 | 0.30 | 0.20 | 0.20 |
| Polymer | (Mw: 38,000, Mn: 8,500, compositional ratio = | | | | | | | | |
| | 40/60 (molar ratio)) | | | | | | | | |
| | the following compound C (Mw: 15,500) | 0.01 | 0.01 | 0.01 | 0.01 | 0.01 | 0.01 | 0.02 | 0.02 |

| | | | | | | | | |
|---|---|---|---|---|---|---|---|---|
| carboxylic acid-containing monomer ARONIX TO-2349 | 0.03 | 0.03 | 0.03 | 0.03 | 0.03 | 0.03 | 0.03 | 0.03 |
| (manufactured by TOAGOSEI CO., LTD.) | | | | | | | | |
| benzotriazole BT-LX (manufactured by JOHOKU CHEMICAL CO., | 0.03 | 0.03 | 0.03 | 0.03 | 0.03 | 0.03 | — | — |
| LTD.) | | | | | | | | |
| 1,2,4-triazole (manufactured by Otsuka Chemical Co., Ltd.) | — | — | — | — | — | — | — | 0.03 |
| adenine (manufactured by Tokyo Chemical Industry Co., Ltd.) | — | — | — | — | — | — | 0.03 | — |
| N-methyldiethanolamine (manufactured by Tokyo Chemical Industry | — | — | — | — | — | — | 0.03 | — |
| Co., Ltd.) | | | | | | | | |
| MEGAFACE F444 (manufactured by DIC Corporation) | 0.01 | 0.01 | 0.01 | 0.01 | 0.01 | 0.01 | 0.01 | 0.01 |
| ion exchange water | 21.5 | 25.2 | 19.8 | 21.6 | 22.8 | 31.7 | 21.5 | 21.6 |
| methanol | 66.0 | 63.0 | 68.0 | 68.0 | 63.0 | 60.0 | 66.0 | 66.0 |

Compound C (See the Following Structural Formula)

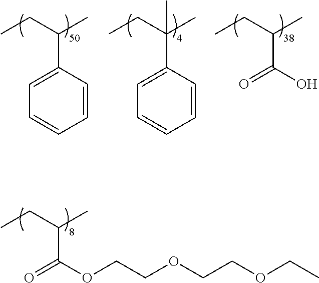

<Preparation of Transfer Film>

(Transfer Film 1 (Used in Examples 1 to 9, 12, 14, 22, 23, and 34 to 41 and Comparative Examples 1 to 4 to be Described Later))

Using a slit-shaped nozzle, the coating liquid A-1 was coated as a coating liquid for forming a first transparent transfer layer onto a temporary support consisting of a polyethylene terephthalate (PET) film 16KS40 (manufactured by Toray Industries, Inc.) having a thickness of 16 μm. The coating amount was adjusted so that the thickness of a first transparent transfer layer to be obtained after drying was 3.0 μm.

After the coating, the coating layer was dried at a drying temperature of 80° C., and a first transparent transfer layer was thus formed.

Next, a polypropylene film 12KW37 (manufactured by Toray Industries, Inc.) as a protective film having a thickness of 12 μm was pressure-bonded to a surface of the first transparent transfer layer to prepare a transfer film 1.

(Transfer Film 2 (Used in Examples 10 and 11 to be Described Later))

Using a slit-shaped nozzle, the coating liquid A-1 was coated as a coating liquid for forming a first transparent transfer layer onto a PET film FR-2 with a release layer (manufactured by Toray Industries, Inc.) having a thickness of 25 μm. The coating amount was adjusted so that the thickness of a first transparent transfer layer to be obtained after drying was 3.0 μm.

After the coating, the coating layer was dried at a drying temperature of 80° C., and a first transparent transfer layer was thus formed.

Next, using a slit-shaped nozzle, the coating liquid B-1 was coated as a coating liquid for forming a third transparent transfer layer onto the first transparent transfer layer. The coating amount was adjusted so that the thickness of a third transparent transfer layer to be obtained after drying was 70 nm.

After that, the coating layer was dried at a drying temperature of 70° C., and a third transparent transfer layer was thus formed.

Next, a PET film 16KS40 (manufactured by Toray Industries, Inc.) having a thickness of 16 μm was pressure-bonded to a surface of the third transparent transfer layer to prepare a transfer film 2.

In the transfer film 2, 16KS40 serves as a temporary support, and the PET film FR-2 with a release layer serves as a protective film.

(Transfer Film 3 (Used in Examples 1 to 11 and Comparative Examples 1 to 4 to be Described Later))

Using a slit-shaped nozzle, the coating liquid A-2 was coated as a coating liquid for forming a second transparent transfer layer onto a temporary support consisting of a PET film 16KS40 (manufactured by Toray Industries, Inc.) having a thickness of 16 μm. The coating amount was adjusted so that the thickness of a second transparent transfer layer to be obtained after drying was 8.0 μm.

After the coating, the coating layer was dried at a drying temperature of 80° C., and a second transparent transfer layer was thus formed.

Next, using a slit-shaped nozzle, the coating liquid for forming a third transparent transfer layer was coated onto the second transparent transfer layer so as to provide the combination in the following Table 5.

In this case, in Example 10 and Comparative Example 3, the coating liquid for forming a third transparent transfer layer was not coated onto the second transparent transfer layer. The coating amount was adjusted so that the thickness of a third transparent transfer layer to be obtained after drying was as described in Table 5. After that, the coating layer was dried at a drying temperature of 70° C., and a third transparent transfer layer was thus formed.

Next, as a protective film, a PET film 16KS40 (manufactured by Toray Industries, Inc.) having a thickness of 16 μm was pressure-bonded to a surface of the third transparent transfer layer to prepare a transfer film 3.

In Example 10 and Comparative Example 3 in which coating with the coating liquid for forming a third transparent transfer layer was not performed, the protective film was directly pressure-bonded to the second transparent transfer layer.

(Transfer Film 4 (Used in Example 12))

Using a slit-shaped nozzle, the coating liquid A-2 was coated as a coating liquid for forming a second transparent transfer layer onto a temporary support consisting of a PET film 16KS40 (manufactured by Toray Industries, Inc.) having a thickness of 16 μm. The coating amount was adjusted so that the thickness of a second transparent transfer layer to be obtained after drying was 8.0 μm.

After the coating, the coating layer was dried at a drying temperature of 80° C., and a second transparent transfer layer was thus formed.

Next, using a slit-shaped nozzle, the coating liquid B-5 was coated as a coating liquid for forming a third transparent transfer layer onto the second transparent transfer layer. The coating amount was adjusted so that the thickness of a third transparent transfer layer to be obtained after drying was as described in Table 5.

After that, the coating layer was dried at a drying temperature of 70° C., and a third transparent transfer layer was thus formed.

Next, using a slit-shaped nozzle, the coating liquid B-6 was coated as a coating liquid for forming a fourth transparent transfer layer onto the third transparent transfer layer. The coating amount was adjusted so that the thickness of a fourth transparent transfer layer to be obtained after drying was as described in Table 5.

After that, the coating layer was dried at a drying temperature of 70° C., and a fourth transparent transfer layer was thus formed.

Next, as a protective film, a PET film 16KS40 (manufactured by Toray Industries, Inc.) having a thickness of 16 μm was pressure-bonded to a surface of the fourth transparent transfer layer to prepare a transfer film 4.

(Transfer Film 5 (Used in Examples 13 and 24 to 33))

Using a slit-shaped nozzle, the coating liquid for forming a first transparent transfer layer was coated onto a PET film FR-2 with a release layer (manufactured by Toray Industries, Inc.) having a thickness of 25 μm so as to provide the combination described in Table 5. The coating amount was adjusted so that the thickness of a first transparent transfer layer to be obtained after drying was as described in Table 5.

After that, the coating layer was dried at a drying temperature of 80° C., and a first transparent transfer layer was thus formed.

Next, using a slit-shaped nozzle, the coating liquid B-1 was coated as a coating liquid for forming a third transparent transfer layer onto the first transparent transfer layer. The coating amount was adjusted so that the thickness of a third transparent transfer layer to be obtained after drying was 64 nm.

After that, the coating layer was dried at a drying temperature of 70° C., and a third transparent transfer layer was thus formed.

Next, a PET film 16KS40 (manufactured by Toray Industries, Inc.) having a thickness of 16 μm was pressure-bonded to a surface of the third transparent transfer layer to prepare a transfer film 5.

In the transfer film 5, the PET film 16KS40 is a temporary support, and the PET film FR-2 with a release layer is a protective film.

(Transfer Film 6 (Used for Forming First Transparent Layer in Examples 15 to 21))

Using a slit-shaped nozzle, the coating liquid for forming a first transparent transfer layer was coated onto a temporary support consisting of a PET film 16KS40 (manufactured by Toray Industries, Inc.) having a thickness of 16 μm so as to provide the combination in Table 5. The coating amount was adjusted so that the thickness of a first transparent transfer layer to be obtained after drying was as described in Table 5.

After that, the coating layer was dried at a drying temperature of 80° C., and a first transparent transfer layer was thus formed.

Next, a polypropylene film 12KW37 (manufactured by Toray Industries, Inc.) as a protective film having a thickness of 12 μm was pressure-bonded to a surface of the first transparent transfer layer to prepare a transfer film 6.

(Transfer Film 7 (Used for Forming Second Transparent Layer and Third Transparent Layer in Examples 13 to 41)

Using a slit-shaped nozzle, the coating liquid for forming a second transparent transfer layer was coated onto a temporary support consisting of a PET film 16KS40 (manufactured by Toray Industries, Inc.) having a thickness of 16 μm so as to provide the combination in Table 5. The coating amount was adjusted so that the thickness of a second transparent transfer layer to be obtained after drying was as described in Table 5.

After that, the coating layer was dried at a drying temperature of 80° C., and a second transparent transfer layer was thus formed.

Next, using a slit-shaped nozzle, the coating liquid for forming a third transparent transfer layer was coated onto the second transparent transfer layer so as to provide the combination in Table 5. The coating amount was adjusted so that the thickness of a third transparent transfer layer to be obtained after drying was as described in Table 5.

After that, the coating layer was dried at a drying temperature of 70° C., and a third transparent transfer layer was thus formed.

Next, as a protective film, a PET film 16KS40 (manufactured by Toray Industries, Inc.) having a thickness of 16 μm was pressure-bonded to a surface of the third transparent transfer layer to prepare a transfer film 7.

The third transparent layer in the preparation of the transfer film 7 is a third transparent layer in the column adjacent to the second transparent layer in Table 5.

<Preparation of Substrate with Transparent Layer>

A cycloolefin resin film having a film thickness of 38 μm and a refractive index of 1.53 was subjected to a corona discharge treatment for surface reforming for 3 seconds under the following conditions using a high frequency oscillator to provide a transparent film substrate (transparent substrate).

(Conditions)

Output Voltage: 100%

Output: 250 W

Electrode: wire electrode having diameter of 1.2 mm

Electrode Length: 240 mm

Distance Between Work Electrodes: 1.5 mm

Next, a coating liquid-C shown in the following Table 3 was coated onto the corona discharge-treated surface of the transparent film substrate using a slit-shaped nozzle. Then, the obtained transparent film substrate was irradiated with ultraviolet rays (integrated light quantity: 300 mJ/cm²) and dried at about 110° C., and thus a transparent layer having a refractive index of 1.62 and a thickness of 80 nm was formed.

In this manner, a substrate with a transparent layer was prepared.

TABLE 3

| | Coating |
|---|---|
| Material | Liquid-C |
| ZrO2: manufactured by Solar Co., Ltd., ZR-010 | 2.08 |
| DPHA liquid (dipentaerythritol hexacrylate: 38%, | 0.29 |
| dipentaerythritol pentaacrylate: 38%, | |
| 1-methoxy-2-propyl acetate: 24%) | |
| urethane-based monomer: UK Oligo UA-32P, | 0.14 |
| manufactured by SHIN-NAKAMURA CHEMICAL | |
| Co., Ltd.: non-volatile content 75%, | |
| 1-methoxy-2-propyl acetate: 25% | |
| monomer mixture (polymerizable compound (b2-1) | 0.36 |
| described in paragraph [0111] in JP2012-78528A, n = | |
| 1: tripentaerythritol octaacrylate content 85%, total of | |
| n = 2 and n = 3 as impurities 15%) | |
| polymer solution 1 (structural formula P-25 described | 1.89 |
| in paragraph [0058] in JP2008-146018: | |
| weight-average molecular weight = 35,000, solid | |
| content 45%, 1-methoxy-2-propyl acetate 15%, | |
| 1-methoxy-2-propanol 40%) | |
| photoradical polymerization initiator: | 0.03 |
| 2-benzyl-2-dimethylamino-1-(4-morpholinophenyl)- | |
| butanone (rgacure (registered trademark) 379, | |
| manufactured by BASF SE) | |
| photopolymerization initiator: KAYACURE DETX-S | 0.03 |
| (manufactured by Nippon Kayaku Co., Ltd, alkyl | |
| thioxanthone) | |
| polymer solution 2 (polymer with structural formula | 0.01 |
| represented by Formula (3): solution with | |
| weight-average molecular weight of 15,000, | |
| non-volatile content 30 mass %, methyl ethyl ketone | |
| 70 mass %) | |
| 1-methoxy-2-propyl acetate | 38.73 |
| methyl ethyl ketone | 56.80 |

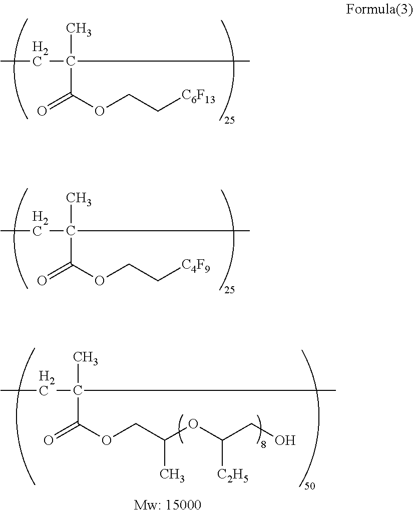

<Preparation of Substrate with Electrode Pattern>

The above-described substrate with a transparent layer was introduced into a vacuum chamber, and an ITO layer (thickness: 40 nm, refractive index: 1.82) was formed on the transparent layer of the substrate with a transparent layer by direct current (DC) magnetron sputtering (conditions: the temperature of the transparent film substrate of the substrate with a transparent layer is 150° C., argon pressure: 0.13 Pa, oxygen pressure: 0.01 Pa) using an ITO target (indium:tin=95:5 (molar ratio)) having a SnO₂ content of 10 mass %.

Thus, a substrate in which the transparent layer and the transparent ITO layer were laminated on the transparent film substrate was obtained. The surface electrical resistance of the ITO layer was 80Ω/□ (Ω per square).

Next, the ITO layer was patterned by etching using a known chemical etching method. Thus, a substrate with an electrode pattern having a first electrode pattern and a plurality of second island-shaped electrode portions on the transparent layer was prepared as shown in FIG. 5.

The first electrode pattern was composed of a plurality of first island-shaped electrode portions and a wiring portion electrically connecting the adjacent first island-shaped electrode portions, and extended in the first direction. A plurality of the first electrode patterns were placed at predetermined intervals in a direction orthogonal to the first direction.

In addition, as shown in FIGS. 5 and 6, the plurality of second island-shaped electrode portions were placed along the second direction orthogonal to the first direction. The plurality of second island-shaped electrode portions were also placed in the first direction at predetermined intervals.

The island-shaped electrode portion (first island-shaped electrode portion and second island-shaped electrode portion) had a size of 2 mm×2 mm, and the wiring portion placed had a width of 100 μm and a length of 500 μm. In addition, a bridge wiring electrode to be described later was formed with a width of 80 μm and a length of 800 μm.

### Example 1

(Formation of First Transparent Resin Layer)

The protective film of the transfer film 1 was peeled off, the surface of the first transparent transfer layer of the transfer film 1 was brought into contact with the electrode pattern (first electrode pattern and a plurality of second island-shaped electrode portions)-forming surface of the substrate with an electrode pattern to perform lamination under the following conditions, and a laminate X was obtained.

(Conditions)

Temperature of Transparent Film Substrate: 40° C.

Temperature of Rubber Roller: 110° C.

Linear Pressure: 3 N/cm

Transportation Speed: 2 m/min

Next, the distance between a surface of an exposure mask (mask for forming through holes) and a surface of the temporary support in the laminate X was set to 125 μm, and the laminate X was exposed to i-rays in a pattern with an exposure amount of 100 mJ/cm² using a proximity type exposure machine (Hitachi High-Tech Corporation) having an ultrahigh pressure mercury lamp.

After that, the temporary support was peeled off from the laminate X. The peeling surface side was subjected to a development treatment for 60 seconds using a 2 mass % aqueous solution of sodium carbonate at a temperature of 32° C., and ultrapure water was sprayed from an ultrahigh pressure washing nozzle to remove residues. The moisture was removed by air blowing. After that, the obtained film was subjected to a post-baking treatment at a temperature of 145° C. for 30 minutes.

In this manner, a laminate Y in which on the transparent film substrate, the transparent layer, the electrode pattern (first electrode pattern and a plurality of second island-shaped electrode portions), and the first transparent resin layer were laminated in this order was prepared. Through holes were formed in the first transparent resin layer (see FIGS. 5 and 6).

(Formation of Bridge Wiring Electrode)

Next, in the same manner as in <Preparation of Substrate with Electrode Pattern>, an ITO layer was formed on the whole surface of the laminate Y on the first transparent resin layer side. In this case, a target whose SnO₂ content was adjusted so as to obtain the refractive index in the column “Transparent Conductive Layer” in Table 5 was used, and the thickness of the ITO layer was also adjusted so as to be the thickness in the column “Transparent Conductive Layer” in Table 5. A bridge wiring electrode (corresponding to the transparent conductive layer) connecting the adjacent second island-shaped electrode portions was formed using a known chemical etching method.

(Formation of Second Transparent Resin Layer)

The protective film of the transfer film 3 was peeled off, the surface of the transfer film 3 on which the third transparent transfer layer was provided was brought into contact with the bridge wiring electrode-forming surface of the laminate Y to perform lamination under the following conditions, and a laminate Z was prepared.

(Conditions)

Temperature of Transparent Film Substrate: 40° C.

Temperature of Rubber Roller: 110° C.

Linear Pressure: 3 N/cm

Transportation Speed: 2 m/min

Then, the distance between a surface of an exposure mask (quartz exposure mask with overcoat pattern) and a surface of the temporary support in the laminate Z was set to 125 μm, and the laminate Z was exposed to i-rays in a pattern with an exposure amount of 100 mJ/cm² using a proximity type exposure machine (Hitachi High-Tech Corporation) having an ultrahigh pressure mercury lamp.

Next, the temporary support was peeled off from the obtained laminate Z. The peeling surface after the peeling of the temporary support was subjected to a development treatment for 60 seconds using a 2 mass % aqueous solution of sodium carbonate at a temperature of 32° C., and ultrapure water was sprayed from an ultrahigh pressure washing nozzle to remove residues. The moisture was removed by air blowing. After that, the obtained laminate was subjected to a post-baking treatment at a temperature of 145° C. for 30 minutes, and a transparent laminate corresponding to a touch sensor was obtained.

The obtained transparent laminate has the first transparent resin layer, the bridge wiring electrode (corresponding to the above-described transparent conductive layer), the third transparent resin layer, and the second transparent resin layer (see FIGS. 5 and 6).

### Examples 2 to 12 and Comparative Examples 1 to 4

Transparent laminates were prepared in the same manner as in Example 1, except that the transfer film used in (Formation of First Transparent Resin Layer) and (Formation of Second Transparent Resin Layer) was replaced as shown in the following Table 4, and a target whose SnO₂ content was adjusted so that an ITO layer to be prepared in (Formation of Bridge Wiring Electrode) had the refractive index and the thickness in Table 5 was used.

### Examples 13 to 41

A transparent laminate was prepared in the same manner as in Example 1, except that the transfer film used in (Formation of First Transparent Resin Layer) and (Formation of Second Transparent Resin Layer) was changed as shown in Table 4.

Table 4 shows the combinations of the transfer films used in Examples 1 to 41 and Comparative Examples 1 to 4.

TABLE 4

| | Formation of First | Formation of Second |
|---|---|---|
| | Transparent | Transparent |
| | Resin Layer | Resin Layer |
| Example 1 | Transfer Film 1 | Transfer Film 3 |
| Example 2 | Transfer Film 1 | Transfer Film 3 |
| Example 3 | Transfer Film 1 | Transfer Film 3 |
| Example 4 | Transfer Film 1 | Transfer Film 3 |
| Example 5 | Transfer Film 1 | Transfer Film 3 |
| Example 6 | Transfer Film 1 | Transfer Film 3 |
| Example 7 | Transfer Film 1 | Transfer Film 3 |
| Example 8 | Transfer Film 1 | Transfer Film 3 |
| Example 9 | Transfer Film 1 | Transfer Film 3 |
| Example 10 | Transfer Film 2 | Transfer Film 3 |
| Example 11 | Transfer Film 2 | Transfer Film 3 |
| Example 12 | Transfer Film 1 | Transfer Film 4 |
| Example 13 | Transfer Film 5 | Transfer Film 7 |
| Example 14 | Transfer Film 1 | Transfer Film 7 |
| Example 15 | Transfer Film 16 | Transfer Film 7 |
| Example 16 | Transfer Film 16 | Transfer Film 7 |
| Example 17 | Transfer Film 16 | Transfer Film 7 |
| Example 18 | Transfer Film 16 | Transfer Film 7 |
| Example 19 | Transfer Film 16 | Transfer Film 7 |
| Example 20 | Transfer Film 16 | Transfer Film 7 |
| Example 21 | Transfer Film 16 | Transfer Film 7 |
| Example 22 | Transfer Film 1 | Transfer Film 7 |
| Example 23 | Transfer Film 1 | Transfer Film 7 |
| Example 24 | Transfer Film 5 | Transfer Film 7 |
| Example 25 | Transfer Film 5 | Transfer Film 7 |
| Example 26 | Transfer Film 5 | Transfer Film 7 |
| Example 27 | Transfer Film 5 | Transfer Film 7 |
| Example 28 | Transfer Film 5 | Transfer Film 7 |
| Example 29 | Transfer Film 5 | Transfer Film 7 |
| Example 30 | Transfer Film 5 | Transfer Film 7 |
| Example 31 | Transfer Film 5 | Transfer Film 7 |
| Example 32 | Transfer Film 5 | Transfer Film 7 |
| Example 33 | Transfer Film 5 | Transfer Film 7 |
| Example 34 | Transfer Film 1 | Transfer Film 7 |
| Example 35 | Transfer Film 1 | Transfer Film 7 |
| Example 36 | Transfer Film 1 | Transfer Film 7 |
| Example 37 | Transfer Film 1 | Transfer Film 7 |
| Example 38 | Transfer Film 1 | Transfer Film 7 |
| Example 39 | Transfer Film 1 | Transfer Film 7 |
| Example 40 | Transfer Film 1 | Transfer Film 7 |
| Example 41 | Transfer Film 1 | Transfer Film 7 |
| Comparative Example 1 | Transfer Film 1 | Transfer Film 3 |
| Comparative Example 2 | Transfer Film 1 | Transfer Film 3 |
| Comparative Example 3 | Transfer Film 1 | Transfer Film 3 |
| Comparative Example 4 | Transfer Film 1 | Transfer Film 3 |

<Evaluation>

The measurement and the evaluation were performed as follows on the transparent laminates prepared as described above. The evaluation results are shown in Table 5.

(1) Reflectivity

Regarding the transparent laminate prepared in each of the above Examples and Comparative Examples, the reflectivity of the transparent laminate with respect to the light from a light source D65 in a part where the bridge wiring electrode was formed (that is, in Example 1, the part having the first transparent resin layer, the bridge wiring electrode, the third transparent resin layer, and the second transparent resin layer in this order) was measured using a spectrophotometer V-570 (manufactured by JASCO Corporation).

In order to perform the measurement, a transparent laminate having a part where the bridge wiring electrode had a size of 5 cm×5 cm was formed in the formation of the transparent laminate, and the reflectivity was measured in the part where the formed bridge wiring electrode had the above size.

(2) Sheet Resistance of Bridge Wiring Electrode

Using a resistivity meter LORESTA GX MCP-T700 (manufactured by Nittoseiko Analytech Co., Ltd.), a four-probe probe was pressed against the exposed bridge wiring electrode after the formation of the bridge wiring electrode in the preparation of the transparent laminate in the above Examples and Comparative Examples, and the sheet resistance was measured.

In order to perform the measurement, a transparent laminate having a part where the bridge wiring electrode had a size of 5 cm×5 cm was formed in the formation of the transparent laminate, and the sheet resistance was measured in the above part.

The measurement results were evaluated according to the following standards and described in Table 5.

A: The sheet resistance is less than 30Ω. There is no problem in driving the touch sensor.

B: The sheet resistance is equal to or greater than 30Ω. Touch sensor sensitivity may not be obtained and problems may occur in driving.

(3) Covering Properties of Electrode Pattern

In the transparent laminate prepared in each of Examples and Comparative Examples, a black PET material was attached to the surface of the transparent film substrate using a transparent adhesive tape (trade name: OCA Tape 8171CL, manufactured by 3M Japan Ltd.) to shield the whole surface of the transparent film substrate from light.

Next, the transparent laminate was placed in a dark room. Fluorescent light was emitted from the second transparent resin layer side (the side opposite to the side on which the black PET material was attached) of the transparent laminate, and the reflected light reflected toward the second transparent resin layer side was visually observed from an oblique direction which was a direction at an acute angle with respect to the normal direction of the second transparent resin layer. In this case, the appearance of the pattern of the bridge wiring electrode observed was evaluated according to the following evaluation standards.

(Evaluation Standards)

A: The bridge wiring electrode is not visible even in a case an observer stares at the electrode from a position 10 cm away from the transparent laminate, and the bridge wiring electrode is not visible even in a case where the observer visually observes the electrode from a position 30 cm away from the transparent laminate.

B: The bridge wiring electrode is slightly visible in a case an observer stares at the electrode from a position 10 cm away from the transparent laminate, and the bridge wiring electrode is not visible in a case where the observer visually observes the electrode from a position 30 cm away from the transparent laminate.

C: The bridge wiring electrode is slightly visible in a case an observer stares at the electrode from a position 10 cm away from the transparent laminate, and the bridge wiring electrode is also slightly visible in a case where the observer visually observes the electrode from a position 30 cm away from the transparent laminate.

D: The bridge wiring electrode is clearly visible in a case an observer stares at the electrode from a position 10 cm away from the transparent laminate, and the bridge wiring electrode is also slightly visible in a case where the observer visually observes the electrode from a position 30 cm away from the transparent laminate.

E: The bridge wiring electrode is clearly visible in a case an observer stares at the electrode from a position 10 cm away from the transparent laminate, and the bridge wiring electrode is also clearly visible in a case where the observer visually observes the electrode from a position 30 cm away from the transparent laminate.

TABLE 5

| | First Transparent | | | Third Transparent | | | Transparent | | | Fourth Transparent | |
|---|---|---|---|---|---|---|---|---|---|---|---|
| | Resin Layer | | | Resin Layer | | | Conductive Layer | | | Resin Layer | |
| | Coating | Refractive | Thickness | Coating | Refractive | Thickness | | Refractive | Thickness | Coating | Refractive |
| | Liquid | Index | (μm) | Liquid | Index | (nm) | Material | Index | (nm) | Liquid | Index |
| Example 1 | Coating | 1.50 | 3.0 | — | — | — | ITO | 2.00 | 120 | — | — |
| | Liquid A-1 | | | | | | | | | | |
| Example 2 | Coating | 1.50 | 3.0 | — | — | — | ITO | 2.00 | 100 | — | — |
| | Liquid A-1 | | | | | | | | | | |
| Example 3 | Coating | 1.50 | 3.0 | — | — | — | ITO | 1.93 | 120 | — | — |
| | Liquid A-1 | | | | | | | | | | |
| Example 4 | Coating | 1.50 | 3.0 | — | — | — | ITO | 1.85 | 120 | — | — |
| | Liquid A-1 | | | | | | | | | | |
| Example 5 | Coating | 1.50 | 3.0 | — | — | — | ITO | 2.00 | 120 | — | — |
| | Liquid A-1 | | | | | | | | | | |
| Example 6 | Coating | 1.50 | 3.0 | — | — | — | ITO | 2.00 | 120 | — | — |
| | Liquid A-1 | | | | | | | | | | |
| Example 7 | Coating | 1.50 | 3.0 | — | — | — | ITO | 2.00 | 120 | — | — |
| | Liquid A-1 | | | | | | | | | | |
| Example 8 | Coating | 1.50 | 3.0 | — | — | — | ITO | 2.00 | 240 | — | — |
| | Liquid A-1 | | | | | | | | | | |
| Example 9 | Coating | 1.50 | 3.0 | — | — | — | ITO | 2.00 | 90 | — | — |
| | Liquid A-1 | | | | | | | | | | |
| Example 10 | Coating | 1.50 | 3.0 | Coating | 1.68 | 70 | ITO | 2.00 | 120 | — | — |
| | Liquid A-1 | | | Liquid B-1 | | | | | | | |
| Example 11 | Coating | 1.50 | 3.0 | Coating | 168 | 70 | ITO | 2.00 | 120 | — | — |
| | Liquid A-1 | | | Liquid B-1 | | | | | | | |
| Example 12 | Coating | 1.50 | 3.0 | — | — | — | ITO | 2.00 | 120 | Coating | 1.45 |
| | Liquid A-1 | | | | | | | | | Liquid B-6 | |
| Example 13 | Coating | 1.50 | 3.0 | Coating | 1.68 | 64 | ITO | 2.00 | 120 | — | — |
| | Liquid A-1 | | | Liquid B-1 | | | | | | | |
| Example 14 | Coating | 1.50 | 3.0 | — | — | — | ITO | 2.00 | 120 | — | — |
| | Liquid A-1 | | | | | | | | | | |
| Example 15 | Coating | 1.50 | 3.0 | — | — | — | ITO | 2.00 | 120 | — | — |
| | Liquid A-2 | | | | | | | | | | |
| Example 16 | Coating | 1.50 | 3.0 | — | — | — | ITO | 2.00 | 120 | — | — |
| | Liquid A-3 | | | | | | | | | | |
| Example 17 | Coating | 1.50 | 3.0 | — | — | — | ITO | 2.00 | 120 | — | — |
| | Liquid A-4 | | | | | | | | | | |
| Example 18 | Coating | 1.50 | 3.0 | — | — | — | ITO | 2.00 | 120 | — | — |
| | Liquid A-5 | | | | | | | | | | |
| Example 19 | Coating | 1.50 | 3.0 | — | — | — | ITO | 2.00 | 120 | — | — |
| | Liquid A-6 | | | | | | | | | | |
| Example 20 | Coating | 1.50 | 5.0 | — | — | — | ITO | 2.00 | 120 | — | — |
| | Liquid A-1 | | | | | | | | | | |
| Example 21 | Coating | 1.50 | 8.0 | — | — | — | ITO | 2.00 | 120 | — | — |
| | Liquid A-1 | | | | | | | | | | |
| Example 22 | Coating | 1.50 | 3.0 | — | — | — | ITO | 2.00 | 120 | — | — |
| | Liquid A-1 | | | | | | | | | | |
| Example 23 | Coating | 1.50 | 3.0 | — | — | — | ITO | 2.00 | 120 | — | — |
| | Liquid A-1 | | | | | | | | | | |
| Example 24 | Coating | 1.50 | 3.0 | Coating | 1.68 | 64 | ITO | 2.00 | 120 | — | — |
| | Liquid A-1 | | | Liquid B-1 | | | | | | | |
| Example 25 | Coating | 1.50 | 3.0 | Coating | 1.68 | 64 | ITO | 2.00 | 120 | — | — |
| | Liquid A-2 | | | Liquid B-1 | | | | | | | |
| Example 26 | Coating | 1.50 | 3.0 | Coating | 1.68 | 64 | ITO | 2.00 | 120 | — | — |
| | Liquid A-3 | | | Liquid B-1 | | | | | | | |
| Example 27 | Coating | 1.50 | 3.0 | Coating | 168 | 64 | ITO | 2.00 | 120 | — | — |
| | Liquid A-4 | | | Liquid B-1 | | | | | | | |
| Example 28 | Coating | 1.50 | 3.0 | Coating | 1.68 | 64 | ITO | 2.00 | 120 | — | — |
| | Liquid A-5 | | | Liquid B-1 | | | | | | | |
| Example 29 | Coating | 1.50 | 3.0 | Coating | 1.68 | 64 | ITO | 2.00 | 120 | — | — |
| | Liquid A-6 | | | Liquid B-1 | | | | | | | |
| Example 30 | Coating | 1.50 | 5.0 | Coating | 168 | 64 | ITO | 2.00 | 120 | — | — |
| | Liquid A-1 | | | Liquid B-1 | | | | | | | |
| Example 31 | Coating | 1.50 | 8.0 | Coating | 1.68 | 64 | ITO | 2.00 | 120 | — | — |
| | Liquid A-1 | | | Liquid B-1 | | | | | | | |
| Example 32 | Coating | 1.50 | 3.0 | Coating | 1.68 | 64 | ITO | 2.00 | 120 | — | — |
| | Liquid A-1 | | | Liquid B-1 | | | | | | | |
| Example 33 | Coating | 1.50 | 3.0 | Coating | 1.68 | 64 | ITO | 2.00 | 120 | — | — |
| | Liquid A-1 | | | Liquid B-1 | | | | | | | |
| Example 34 | Coating | 1.50 | 3.0 | — | — | — | ITO | 2.00 | 120 | — | — |
| | Liquid A-1 | | | | | | | | | | |
| Example 35 | Coating | 1.50 | 3.0 | — | — | — | ITO | 2.00 | 120 | — | — |
| | Liquid A-1 | | | | | | | | | | |
| Example 36 | Coating | 1.50 | 3.0 | — | — | — | ITO | 2.00 | 120 | — | — |
| | Liquid A-1 | | | | | | | | | | |
| Example 37 | Coating | 1.50 | 3.0 | — | — | — | ITO | 2.00 | 120 | — | — |
| | Liquid A-1 | | | | | | | | | | |
| Example 38 | Coating | 1.50 | 3.0 | — | — | — | ITO | 2.00 | 120 | — | — |
| | Liquid A-1 | | | | | | | | | | |
| Example 39 | Coating | 1.50 | 3.0 | — | — | — | ITO | 2.00 | 120 | — | — |
| | Liquid A-1 | | | | | | | | | | |
| Example 40 | Coating | 1.50 | 3.0 | — | — | — | ITO | 2.00 | 120 | — | — |
| | Liquid A-1 | | | | | | | | | | |
| Example 41 | Coating | 1.50 | 3.0 | — | — | — | ITO | 2.00 | 120 | — | — |
| | Liquid A-1 | | | | | | | | | | |
| Comparative | Coating | 1.50 | 3.0 | — | — | — | ITO | 2.00 | 80 | — | — |
| Example 1 | Liquid A-1 | | | | | | | | | | |
| Comparative | Coating | 1.50 | 3.0 | — | — | — | ITO | 2.00 | 200 | — | — |
| Example 2 | Liquid A-1 | | | | | | | | | | |
| Comparative | Coating | 1.50 | 3.0 | — | — | — | ITO | 2.00 | 100 | — | — |
| Example 3 | Liquid A-1 | | | | | | | | | | |
| Comparative | Coating | 1.50 | 3.0 | — | — | — | ITO | 2.00 | 40 | — | — |
| Example 4 | Liquid A-1 | | | | | | | | | | |

Evaluation

| | Fourth Transparent | Third Transparent | | | Second Transparent | | | | | Covering |
|---|---|---|---|---|---|---|---|---|---|---|
| | Resin Layer | Resin Layer | | | Resin Layer | | | | | Properties of |
| | Thickness | Coating | Refractive | Thickness | Coating | Refractive | Thickness | Reflec- | Sheet | Electrode |
| | (nm) | Liquid | Index | (nm) | Liquid | Index | (gm) | tivity | Resistance | Pattern |
| Example 1 | — | Coating | 1.68 | 70 | Coating | 1.50 | 8.0 | 3.2% | A | A |
| | | Liquid B-1 | | | Liquid A-2 | | | | | |
| Example 2 | — | Coating | 1.70 | 55 | Coating | 1.50 | 8.0 | 3.2% | A | A |
| | | Liquid B-2 | | | Liquid A-2 | | | | | |
| Example 3 | — | Coating | 1.68 | 70 | Coating | 1.50 | 8.0 | 3.1% | A | A |
| | | Liquid B-1 | | | Liquid A-2 | | | | | |
| Example 4 | — | Coating | 1.68 | 70 | Coating | 1.50 | 8.0 | 2.8% | A | A |
| | | Liquid B-1 | | | Liquid A-2 | | | | | |
| Example 5 | — | Coating | 1.65 | 70 | Coating | 1.50 | 8.0 | 3.0% | A | B |
| | | Liquid B-3 | | | Liquid A-2 | | | | | |
| Example 6 | — | Coating | 1.55 | 70 | Coating | 1.50 | 8.0 | 3.0% | A | D |
| | | Liquid B-4 | | | Liquid A-2 | | | | | |
| Example 7 | — | Coating | 1.68 | 230 | Coating | 1.50 | 8.0 | 3.5% | A | D |
| | | Liquid B-1 | | | Liquid A-2 | | | | | |
| Example 8 | — | Coating | 1.68 | 70 | Coating | 1.50 | 8.0 | 4.1% | A | C |
| | | Liquid B-1 | | | Liquid A-2 | | | | | |
| Example 9 | — | Coating | 1.68 | 70 | Coating | 1.50 | 8.0 | 4.6% | A | C |
| | | Liquid B-1 | | | Liquid A-2 | | | | | |
| Example 10 | — | — | — | — | Coating | 1.50 | 8.0 | 3.2% | A | A |
| | | | | | Liquid A-2 | | | | | |
| Example 11 | — | Coating | 1.68 | 70 | Coating | 1.50 | 8.0 | 1.8% | A | A |
| | | Liquid B-1 | | | Liquid A-2 | | | | | |
| Example 12 | 25 | Coating | 1.80 | 25 | Coating | 1.50 | 8.0 | 2.9% | A | A |
| | | Liquid B-5 | | | Liquid A-2 | | | | | |
| Example 13 | — | Coating | 1.68 | 64 | Coating | 1.50 | 8.0 | 1.7% | A | A |
| | | Liquid B-1 | | | Liquid A-2 | | | | | |
| Example 14 | — | Coating | 1.68 | 70 | Coating | 1.50 | 8.0 | 3.2% | A | A |
| | | Liquid B-1 | | | Liquid A-1 | | | | | |
| Example 15 | — | Coating | 1.68 | 70 | Coating | 1.50 | 8.0 | 3.2% | A | A |
| | | Liquid B-1 | | | Liquid A-2 | | | | | |
| Example 16 | — | Coating | 1.68 | 70 | Coating | 1.50 | 8.0 | 3.2% | A | A |
| | | Liquid B-1 | | | Liquid A-3 | | | | | |
| Example 17 | — | Coating | 1.68 | 70 | Coating | 1.50 | 8.0 | 3.2% | A | A |
| | | Liquid B-1 | | | Liquid A-4 | | | | | |
| Example 18 | — | Coating | 1.68 | 70 | Coating | 1.50 | 8.0 | 3.2% | A | A |
| | | Liquid B-1 | | | Liquid A-5 | | | | | |
| Example 19 | — | Coating | 1.68 | 70 | Coating | 150 | 8.0 | 3.2% | A | A |
| | | Liquid B-1 | | | Liquid A-6 | | | | | |
| Example 20 | — | Coating | 1.68 | 70 | Coating | 1.50 | 8.0 | 3.2% | A | A |
| | | Liquid B-1 | | | Liquid A-2 | | | | | |
| Example 21 | — | Coating | 1.68 | 70 | Coating | 1.50 | 8.0 | 3.2% | A | A |
| | | Liquid B-1 | | | Liquid A-2 | | | | | |
| Example 22 | — | Coating | 1.68 | 70 | Coating | 1.50 | 3.0 | 3.2% | A | A |
| | | Liquid B-1 | | | Liquid A-2 | | | | | |
| Example 23 | — | Coating | 1.68 | 70 | Coating | 1.50 | 5.0 | 3.2% | A | A |
| | | Liquid B-1 | | | Liquid A-2 | | | | | |
| Example 24 | — | Coating | 1.68 | 64 | Coating | 1.50 | 8.0 | 1.7% | A | A |
| | | Liquid B-1 | | | Liquid A-1 | | | | | |
| Example 25 | — | Coating | 1.68 | 70 | Coating | 1.50 | 8.0 | 1.7% | A | A |
| | | Liquid B-1 | | | Liquid A-2 | | | | | |
| Example 26 | — | Coating | 1.68 | 70 | Coating | 1.50 | 8.0 | 1.7% | A | A |
| | | Liquid B-1 | | | Liquid A-3 | | | | | |
| Example 27 | — | Coating | 1.68 | 70 | Coating | 1.50 | 8.0 | 1.7% | A | A |
| | | Liquid B-1 | | | Liquid A-4 | | | | | |
| Example 28 | — | Coating | 1.68 | 70 | Coating | 1.50 | 8.0 | 1.7% | A | A |
| | | Liquid B-1 | | | Liquid A-5 | | | | | |
| Example 29 | — | Coating | 1.68 | 70 | Coating | 1.50 | 8.0 | 1.7% | A | A |
| | | Liquid B-1 | | | Liquid A-6 | | | | | |
| Example 30 | — | Coating | 1.68 | 70 | Coating | 1.50 | 8.0 | 1.7% | A | A |
| | | Liquid B-1 | | | Liquid A-2 | | | | | |
| Example 31 | — | Coating | 1.68 | 70 | Coating | 1.50 | 8.0 | 1.7% | A | A |
| | | Liquid B-1 | | | Liquid A-2 | | | | | |
| Example 32 | — | Coating | 1.68 | 70 | Coating | 1.50 | 3.0 | 1.7% | A | A |
| | | LiquidB-1 | | | Liquid A-2 | | | | | |
| Example 33 | — | Coating | 1.68 | 70 | Coating | 1.50 | 5.0 | 1.7% | A | A |
| | | Liquid B-1 | | | Liquid A-2 | | | | | |
| Example 34 | — | Coating | 1.68 | 70 | Coating | 1.50 | 8.0 | 3.2% | A | A |
| | | Liquid B-7 | | | Liquid A-3 | | | | | |
| Example 35 | — | Coating | 1.68 | 70 | Coating | 1.50 | 8.0 | 3.2% | A | A |
| | | Liquid B-7 | | | Liquid A-4 | | | | | |
| Example 36 | — | Coating | 1.68 | 70 | Coating | 1.50 | 8.0 | 3.2% | A | A |
| | | Liquid B-7 | | | Liquid A-5 | | | | | |
| Example 37 | — | Coating | 1.68 | 70 | Coating | 1.50 | 8.0 | 3.2% | A | A |
| | | Liquid B-7 | | | Liquid A-6 | | | | | |
| Example 38 | — | Coating | 1.68 | 70 | Coating | 1.50 | 8.0 | 3.2% | A | A |
| | | Liquid B-8 | | | Liquid A-3 | | | | | |
| Example 39 | — | Coating | 1.68 | 70 | Coating | 1.50 | 8.0 | 3.2% | A | A |
| | | Liquid B-8 | | | Liquid A-4 | | | | | |
| Example 40 | — | Coating | 1.68 | 70 | Coating | 1.50 | 8.0 | 3.2% | A | A |
| | | Liquid B-8 | | | Liquid A-5 | | | | | |
| Example 41 | — | Coating | 1.68 | 70 | Coating | 1.50 | 8.0 | 3.2% | A | A |
| | | Liquid B-8 | | | Liquid A-6 | | | | | |
| Comparative | — | Coating | 1.68 | 70 | Coating | 1.50 | 8.0 | 5.0% | A | D |
| Example 1 | | Liquid B-1 | | | Liquid A-2 | | | | | |
| Comparative | — | Coating | 1.68 | 70 | Coating | 1.50 | 8.0 | 5.0% | A | D |
| Example 2 | | Liquid B-1 | | | Liquid A-2 | | | | | |
| Comparative | — | — | | | Coating | 1.50 | 8.0 | 6.1% | A | E |
| Example 3 | | | | | Liquid A-2 | | | | | |
| Comparative | — | Coating | 1.68 | 70 | Coating | 1.50 | 8.0 | 4.1% | B | B |
| Example 4 | | Liquid B-1 | | | Liquid A-2 | | | | | |

As shown in Table 5, it has been confirmed that desired effects are obtained with the transparent laminate according to the embodiment of the invention.

Above all, from the comparison between Examples 1 to 6, it has been confirmed that in a case where the refractive index of the third transparent resin layer was equal to or greater than 1.60, the covering properties of the electrode pattern are further improved.

From the comparison between Examples 1 and 7, it has been confirmed that in a case where the thickness of the third transparent resin layer is equal to or greater than 200 nm, the reflectivity is further reduced and the covering properties of the electrode pattern are further improved.

From the comparison between Examples 1 and 8, it has been confirmed that in a case where n is 1 in Expression (1), the reflectivity is further reduced and the covering properties of the electrode pattern are further improved.

From the comparison between Example 1 and Examples 8 and 9, it has been confirmed that in a case where the thickness of the transparent conductive layer is 100 to 160 nm, the reflectivity is further reduced and the covering properties of the electrode pattern are further improved.

From the comparison between Examples 1 and 11, it has been confirmed that in a case where the transparent laminate has a third transparent resin layer both between the first transparent resin layer and the transparent conductive layer and between the transparent conductive layer and the second transparent resin layer, the reflectivity is further reduced.

From the comparison between Examples 1 and 12, it has been confirmed that in a case where the transparent laminate further has a fourth transparent resin layer having a lower refractive index than the third transparent resin layer between the transparent conductive layer and the third transparent resin layer, the reflectivity is further reduced.

### EXPLANATION OF REFERENCES

10A, 10B, 10C, 10D, 10E: transparent laminate
12: first transparent resin layer
14, 14A: transparent conductive layer
16, 16A, 16B: third transparent resin layer
18: second transparent resin layer
20: fourth transparent resin layer
22: transparent substrate
24: transparent layer
26: first electrode pattern
28: second island-shaped electrode portion
30: second electrode pattern
32: first island-shaped electrode portion
34: wiring portion
36: through hole

What is claimed is:

1. A transparent laminate comprising in order:
a first transparent resin layer;
a transparent conductive layer; and
a second transparent resin layer,
wherein a third transparent resin layer having a higher refractive index than the first and second transparent resin layers is provided at least one of between the first transparent resin layer and the transparent conductive layer, or between the transparent conductive layer and the second transparent resin layer, and
a thickness T of the transparent conductive layer satisfies a relationship represented by Expression (1),
{(n×550/4)−50} nm≤T≤{(n×550/4)+50} nm Expression (1)
where n represents an integer of 1 or more.

2. The transparent laminate according to claim 1,
wherein the third transparent resin layer has a refractive index equal to or greater than 1.60.

3. The transparent laminate according to claim 1,
wherein the third transparent resin layer has a thickness equal to or less than 200 nm.

4. The transparent laminate according to claim 1,
wherein n is 1 in Expression (1).

5. The transparent laminate according to claim 1,
wherein the transparent conductive layer has a thickness of 100 to 160 nm.

6. The transparent laminate according to claim 1,
wherein the third transparent resin layer is provided both between the first transparent resin layer and the transparent conductive layer and between the transparent conductive layer and the second transparent resin layer.

7. The transparent laminate according to claim 1,
wherein a fourth transparent resin layer having a lower refractive index than the third transparent resin layer is further provided between the transparent conductive layer and the third transparent resin layer.

8. The transparent laminate according to claim 1,
wherein the third transparent resin layer contains metal oxide particles.

9. The transparent laminate according to claim 1,
wherein the transparent laminate is used as a touch sensor.

10. An image display apparatus comprising:
an image display element; and
the transparent laminate according to claim 9.
